(19) United States
(12) Patent Application Publication
(10) Pub. No.: US 2023/0027461 A1
(43) Pub. Date: Jan. 26, 2023

(54) DRIVING FORCE CONTROL SYSTEM FOR HYBRID VEHICLE

(71) Applicant: TOYOTA JIDOSHA KABUSHIKI KAISHA, Toyota-shi (JP)

(72) Inventors: Taku HARADA, Nisshin-shi (JP); Michitaka TSUCHIDA, Miyoshi-shi (JP); Tatsuya IMAMURA, Okazaki-shi (JP)

(73) Assignee: TOYOTA JIDOSHA KABUSHIKI KAISHA, Toyota-shi (JP)

(21) Appl. No.: 17/827,078

(22) Filed: May 27, 2022

(30) Foreign Application Priority Data
Jul. 26, 2021 (JP) 2021-121800

(51) Int. Cl. B60W 20/19; B60W 10/06; B60W 10/08; B60W 20/40

(52) U.S. Cl. CPC B60W 20/19; B60W 10/06; B60W 10/08; B60W 20/40; B60W 2710/0666; B60W 2710/083; B60W 2520/06; B60W 2520/10; B60W 2710/0644; B60W 2510/244

(57) ABSTRACT

A driving force control system for a hybrid vehicle for reducing a required time to launch the hybrid vehicle after selecting a reverse range while maintaining a driving force. The control system is configured to change an engine start threshold to restrict a startup of the engine upon satisfaction of a restricting condition, in which a low mode is established by a transmission mechanism, and a reverse drive range is selected.

### CROSS-REFERENCE TO RELATED APPLICATIONS

The present disclosure claims the benefit of Japanese Patent Application No. 2021-121800 filed on Jul. 26, 2021 with the Japanese Patent Office, the disclosures of which are incorporated herein by reference in its entirety.

### BACKGROUND

### Field of the Disclosure

Embodiments of the present disclosure relate to the art of a driving force control system for a hybrid vehicle comprising a differential mechanism connected to an engine and a first motor, and a second motor connected to an output member of the differential mechanism.

### Discussion of the Related Art

JP-B2-6451524 describes a hybrid vehicle comprising a power split mechanism that distributes an output torque of an engine to a first motor and to an output side. A kinetic power delivered from the engine to the first motor is translated to an electric power by the first motor, and further delivered to a second motor. An output torque of the second motor is synthesized with the torque of the engine. In the power split mechanism described in JP-B2-6451524, a low mode in which a ratio of the torque delivered to the output side to the torque delivered to the first motor is relatively large is established by engaging one of engagement devices, and a high mode in which the above-mentioned ratio is relatively small is established by engaging another one of engagement devices.

In the hybrid vehicle taught by JP-B2-6451524, the first motor generates a reaction torque during operation of the engine to suppress a raise in a speed of the engine, and consequently the torque of the engine is partially delivered to drive wheels. Specifically, a powertrain of the hybrid vehicle taught by JP-B2-6451524 is adapted to deliver the torque of the engine to the drive wheel through the power split mechanism in a direction to propel the hybrid vehicle in the forward direction. That is, the direction of the torque delivered to the drive wheels is governed by the direction of the torque generated by the engine. When reversing the hybrid vehicle taught by JP-B2-6451524, therefore, the second motor generates a reverse torque but it is smaller than the drive torque generated by the engine.

As described, in the hybrid vehicle taught by JP-B2-6451524, the torque delivered to the drive wheels in the high mode is less than the torque delivered to the drive wheels in the low mode. Therefore, in order to avoid such reduction in the drive torque, it is preferable to select the high mode when reversing the hybrid vehicle of this kind. Whereas, in a case of propelling the hybrid vehicle in the forward direction at a low speed, a large drive torque which may not be generated only by the second motor is required, and energy losses of the engine and the motors has to be reduced. In this case, therefore, it is preferable to select the low mode.

However, in a case of shifting an operating range when e.g., reversing a stopping vehicle by operating a range selector lever, an engagement device(s) is/are manipulated to establish a desired mode after completion of operation of the range selector lever. In this case, therefore, it will take some time to launch the vehicle and hence a driver would be frustrated.

### SUMMARY

Aspects of embodiments of the present disclosure have been conceived noting the foregoing technical problems, and it is therefore an object of the present disclosure to provide a driving force control system for a hybrid vehicle that is configured to reduce a required time to launch the hybrid vehicle after operating a range selector lever, and to avoid a reduction in a driving force when reversing the hybrid vehicle.

According to one aspect of the present disclosure, there is provided a driving force control system that is applied to a hybrid vehicle comprising: an engine; a first rotary machine; and a transmission mechanism comprising a first rotary element, a second rotary element, and a third rotary element connected to one another while being allowed to rotate in a differential manner. In the transmission mechanism, the first rotary element is connected to the engine, the second rotary element is connected to the first rotary machine, and the third rotary element is connected to an output member. In the hybrid vehicle, an output torque of the engine is delivered to the output member by generating a reaction torque by the first rotary machine. The transmission mechanism is configured to establish: a low mode in which the output torque of the engine is delivered to the output member at a first predetermined ratio; and a high mode in which the output torque of the engine is delivered to the output member at a second predetermined ratio that is smaller than the first predetermined ratio. The hybrid vehicle to which driving force control system is applied further comprises: a second rotary machine that is connected to the output member in a torque transmittable manner; and an electric storage device that is electrically connected to the first rotary machine and the second rotary machine. The hybrid vehicle is propelled in reverse by generating a reverse torque by the second rotary machine, and the output torque of the engine delivered to the output member through the transmission mechanism counteracts the reverse torque. In order to achieve the above-explained objective, according to the present disclosure, the driving force control system is provided with a controller that controls the engine, the first rotary machine, and the second rotary machine. According to one aspect of the present disclosure, the controller is configured to change an engine start threshold to restrict a startup of the engine upon satisfaction of a restricting condition, in which the low mode is established by the transmission mechanism, and a reverse drive range is selected.

In a non-limiting embodiment, a required driving force or a required power to propel the hybrid vehicle may be employed as a parameter of the engine start threshold. In addition, the controller may be further configured to: start the engine when the required driving force or the required power is increased to or greater than the engine start threshold; and increase the engine start threshold upon satisfaction of the restricting condition.

In a non-limiting embodiment, the first rotary machine may translate a power generated by the engine into an electric power to be supplied to the electric storage device, and the engine start threshold may include a charge start threshold level of a state of charge level of the electric storage device. In addition, the controller may be further configured to: start the engine when the state of charge level of the electric storage device falls to the charge start threshold level or lower; and lower the charge start threshold level upon satisfaction of the restricting condition.

In a non-limiting embodiment, the controller may be further configured to: set an output power of the engine to a total power of a required power to propel the hybrid vehicle and a required power to charge the electric storage device when operating the engine; and reduce the output torque of the engine upon satisfaction of the restricting condition.

According to another aspect of the present disclosure, there is provided a driving force control system that is applied to a hybrid vehicle comprising: an engine; a first rotary machine; and a transmission mechanism comprising a first rotary element, a second rotary element, and a third rotary element connected to one another while being allowed to rotate in a differential manner. In the transmission mechanism, the first rotary element is connected to the engine, the second rotary element is connected to the first rotary machine, and the third rotary element is connected to an output member. In the hybrid vehicle, an output torque of the engine is delivered to the output member by generating a reaction torque by the first rotary machine. The transmission mechanism is configured to establish: a low mode in which the output torque of the engine is delivered to the output member at a first predetermined ratio; and a high mode in which the output torque of the engine is delivered to the output member at a second predetermined ratio that is smaller than the first predetermined ratio. The hybrid vehicle to which driving force control system is applied further comprises: a second rotary machine that is connected to the output member in a torque transmittable manner; and an electric storage device that is electrically connected to the first rotary machine and the second rotary machine. The hybrid vehicle is propelled in reverse by generating a reverse torque by the second rotary machine, and the output torque of the engine delivered to the output member through the transmission mechanism counteracts the reverse torque. In order to achieve the above-explained objective, according to the present disclosure, the driving force control system is provided with a controller that controls the engine, the first rotary machine, and the second rotary machine. According to another aspect of the present disclosure, the controller may be configured to: set an output power of the engine to a total power of a required power to propel the hybrid vehicle and a required power to charge the electric storage device when operating the engine; and reduce the output torque of the engine upon satisfaction of a restricting condition, in which the low mode is established by the transmission mechanism, and a reverse drive range is selected.

In a non-limiting embodiment, the controller may be further configured to reduce the output torque of the engine by increasing a speed of the engine while maintaining the output power of the engine upon satisfaction of the restricting condition.

In a non-limiting embodiment, the controller may be further configured to reduce the output torque of the engine by reducing the required power to charge the electric storage device by the engine upon satisfaction of the restricting condition.

In a non-limiting embodiment, the controller may be further configured to control the transmission mechanism to shift from the low mode to the high mode, and to return the engine start threshold which has been changed to an initial value, after a lapse of a predetermined period of time from a point at which the hybrid vehicle has started to propel in reverse.

In a non-limiting embodiment, the controller may be further configured to control the transmission mechanism to shift from the low mode to the high mode, and to increase the output torque of the engine which has been reduced to a normal value, after a lapse of a predetermined period of time from a point at which the hybrid vehicle has started to propel in reverse.

In a non-limiting embodiment, the controller may be further configured to: determine whether the hybrid vehicle is expected to travel in reverse on a road where a driving force greater than a predetermined value is required; and change the engine start threshold if the hybrid vehicle is expected to travel in reverse on the road where the driving force greater than the predetermined value is required.

In a non-limiting embodiment, the controller may be further configured to: determine whether the hybrid vehicle is expected to travel in reverse on a road where a driving force greater than a predetermined value is required; and reduce the output torque of the engine if the hybrid vehicle is expected to travel in reverse on the road where the driving force greater than the predetermined value is required.

In a non-limiting embodiment, the controller may be further configured to: determine whether the hybrid vehicle moving in reverse approaches a road where a driving force greater than a predetermined value is required; and increase an electric power to be charged into the electric storage device if the hybrid vehicle moving in reverse approaches the road where the driving force greater than the predetermined value is required.

According to still another aspect of the present disclosure, there is provided a driving force control system that is applied to a hybrid vehicle comprising: an engine; a first rotary machine; and a transmission mechanism comprising a first rotary element, a second rotary element, and a third rotary element connected to one another while being allowed to rotate in a differential manner. In the transmission mechanism, the first rotary element is connected to the engine, the second rotary element is connected to the first rotary machine, and the third rotary element is connected to an output member. In the hybrid vehicle, an output torque of the engine is delivered to the output member by generating a reaction torque by the first rotary machine. The transmission mechanism is configured to establish: a low mode in which the output torque of the engine is delivered to the output member at a first predetermined ratio; and a high mode in which the output torque of the engine is delivered to the output member at a second predetermined ratio that is smaller than the first predetermined ratio. The hybrid vehicle to which driving force control system is applied further comprises: a second rotary machine that is connected to the output member in a torque transmittable manner; and an electric storage device that is electrically connected to the first rotary machine and the second rotary machine. The hybrid vehicle is propelled in reverse by generating a reverse torque by the second rotary machine, and the output torque of the engine delivered to the output member through the transmission mechanism counteracts the reverse torque. In order to achieve the above-explained objective, according to the present disclosure, the driving force control system is provided with a controller that controls the engine, the first rotary machine, and the second rotary machine. According to still another aspect of the present disclosure, the controller may be configured to: determine whether the hybrid vehicle moving in reverse approaches a road where a driving force greater than a predetermined value is required; and increase an electric power to be charged into the electric storage device if the hybrid vehicle moving in reverse approaches the road where the driving force greater than the predetermined value is required.

In a non-limiting embodiment, the controller may be further configured to start the engine to increase the electric power to be charged into the electric storage device, if the engine was stopped when the hybrid vehicle approached the road where the driving force greater than the predetermined value is required.

As described, in the hybrid vehicle to which the driving force control system according to the exemplary embodiment of the present disclosure is applied, the output torque of the engine is delivered to the output member by generating the reaction torque by the first motor, and the output torque of the engine thus delivered to the output member counteracts the reverse torque. As also described, the torque delivered to the output member in the low mode is greater than the torque delivered to the output member in the high mode. In the hybrid vehicle of this kind, the driving force to propel the hybrid vehicle in reverse is reduced by the torque of the engine delivered to the output member. In order to avoid such disadvantage, the driving force control system according to the exemplary embodiment of the present disclosure is configured to change the engine start threshold to restrict a startup of the engine when the low mode is established by the transmission mechanism, and the reverse drive range is selected. Consequently, an operating region of the hybrid vehicle in which the hybrid vehicle is powered only by the second rotary machine is widened, compared to the case in which the engine start threshold is not changed. According to the exemplary embodiment of the present disclosure, therefore, the hybrid vehicle is allowed to be propelled in reverse only by the second rotary machine in the low mode. For this reason, a required time to launch the hybrid vehicle in reverse after selecting the reverse drive range may be reduced.

In addition, in the case that the low mode is established by the transmission mechanism and the reverse drive range is selected, the torque counteracting the reverse torque can be reduced by reducing the output torque of the engine. That is, the driving force to propel the hybrid vehicle in reverse will not be reduced. According to the exemplary embodiment of the present disclosure, therefore, the hybrid vehicle is allowed to be propelled in reverse in the low mode. For this reason, the required time to launch the hybrid vehicle in reverse after selecting the reverse drive range may be reduced.

Further, when the hybrid vehicle moving in reverse approaches an upward slope, the electric storage device is charged by increasing the required power to charge the electric storage device. According to the exemplary embodiment of the present disclosure, therefore, a state of charge level of the electric storage device may be maintained to a higher level when the hybrid vehicle starts climbing the slope in reverse. Consequently, an available electric power or energy of the electric storage device to be supplied to the second rotary machine may be increased. For this reason, a greater driving force to propel the hybrid vehicle in reverse may be established, and a distance to propel the hybrid vehicle in reverse may be increased. That is, the hybrid vehicle is allowed to launch in reverse on an upward slope without manipulating the clutches. For this reason, a required time to launch the hybrid vehicle in reverse on an upward slope after selecting the reverse drive range may be reduced.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram showing one example of a powertrain of a hybrid vehicle to which the driving force control system according to the embodiment of the present disclosure is applied;

FIG. 2 is a table showing engagement states of engagement devices and operating conditions of prime movers in each operating mode;

FIG. 3 is a nomographic diagram showing a situation of the powertrain shown in FIG. 1 in a HV-High mode;

FIG. 4 is a nomographic diagram showing a situation of the powertrain shown in FIG. 1 in a HV-Low mode;

FIG. 5 is a nomographic diagram showing a situation of the powertrain shown in FIG. 1 in a fixed mode;

FIG. 6 is a nomographic diagram showing a situation of the powertrain shown in FIG. 1 in an EV-Low mode;

FIG. 7 is a nomographic diagram showing a situation of the powertrain shown in FIG. 1 in the EV-High mode;

FIG. 8 is a nomographic diagram showing a situation of the powertrain shown in FIG. 1 in a single-motor mode;

FIG. 9 is a flowchart showing a first example of a routine executed by the driving force control system according to the embodiment of the present disclosure;

FIG. 10 is a time chart showing a temporal change in an engine start threshold during execution of the routine shown in FIG. 9;

FIG. 11 is a flowchart showing a second example of a routine executed by the driving force control system according to the embodiment of the present disclosure;

FIG. 12 is a time chart showing a temporal change in a charge start threshold level during execution of the routine shown in FIG. 11;

FIG. 13 is a flowchart showing a third example of the routine executed by the driving force control system according to the embodiment of the present disclosure;

FIG. 14 is a time chart showing temporal changes in conditions of the engine during execution of the routine shown in FIG. 13;

FIG. 15 is a flowchart showing a fourth example of the routine executed by the driving force control system according to the embodiment of the present disclosure;

FIG. 16 is a time chart showing temporal changes in conditions of the engine and a required power to charge an electric storage device during execution of the routine shown in FIG. 15;

FIG. 17 is a flowchart showing a fifth example of the routine executed by the driving force control system according to the embodiment of the present disclosure;

FIG. 18 is a time chart showing a temporal change in the engine start threshold during execution of the routine shown in FIG. 17;

FIG. 19 is a flowchart showing a sixth example of the routine executed by the driving force control system according to the embodiment of the present disclosure;

FIG. 20 is a time chart showing a temporal change in the charge start threshold level of the electric storage device during execution of the routine shown in FIG. 19;

FIG. 21 is a flowchart showing a seventh example of the routine executed by the driving force control system according to the embodiment of the present disclosure;

FIG. 22 is a time chart showing temporal changes in conditions of the engine during execution of the routine shown in FIG. 21;

FIG. 23 is a flowchart showing an eighth example of the routine executed by the driving force control system according to the embodiment of the present disclosure;

FIG. 24 is a time chart showing temporal changes in conditions of the engine and the required power to be generated by the engine to charge the electric storage device during execution of the routine shown in FIG. 23;

FIG. 25 is a flowchart showing a ninth example of the routine executed by the driving force control system according to the embodiment of the present disclosure;

FIG. 26 is a flowchart showing a tenth example of the routine executed by the driving force control system according to the embodiment of the present disclosure; and

FIG. 27 is a time chart showing a temporal change in the required power to be generated by the engine to charge the electric storage device during execution of the routine shown in FIG. 26.

### DETAILED DESCRIPTION OF THE PREFERRED EMBODIMENT(S)

The driving force control system according to the exemplary embodiment of the present disclosure is applied to a hybrid vehicle in which a torque generated by an engine is distributed to a first motor and drive wheels. An operating mode of the hybrid vehicle may be selected from a low mode in which the torque delivered to the drive wheels is relatively large, and a high mode in which the torque delivered to the drive wheels is relatively small.

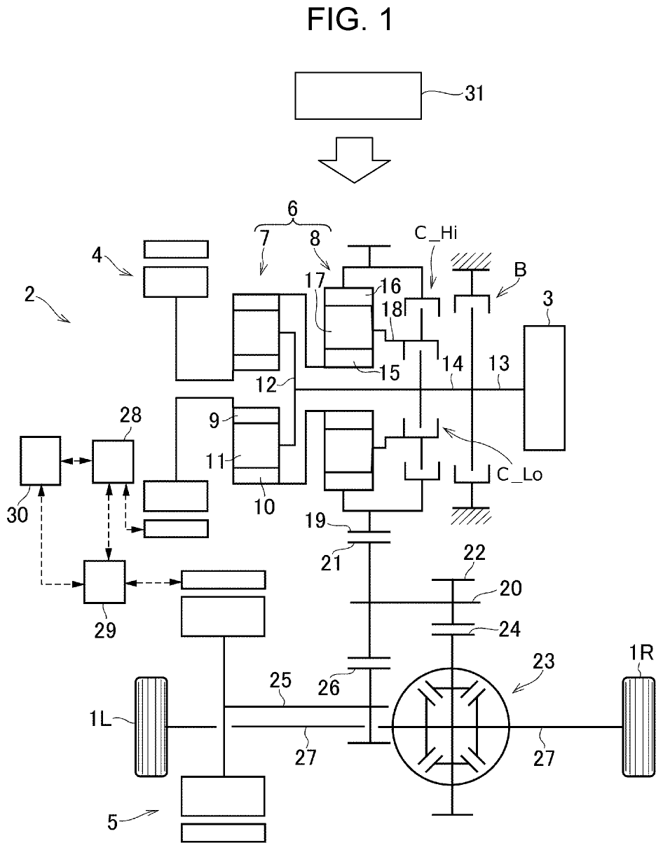

Embodiments of the present disclosure will now be explained with reference to the accompanying drawings. Referring now to FIG. 1, there is shown one example of a structure of a hybrid vehicle (as will be simply called the “vehicle” hereinafter) to which the driving force control system according to the embodiment is applied. Specifically, FIG. 1 shows a powertrain 2 of the vehicle that drives a pair of front wheels 1R and 1L, and a prime mover of the powertrain 2 includes an engine (referred to as “ENG” in the drawings) 3, a first motor (referred to as “MG1” in the drawings) 4 as a first rotary machine, and a second motor (referred to as “MG2” in the drawings) 5 as a second rotary machine. According to the exemplary embodiment of the present disclosure, a motor-generator having a generating function is adopted as the first motor 4. In the powertrain 2, a speed of the engine 3 is controlled by the first motor 4, and the second motor 5 is driven by an electric power generated by the first motor 4 to generate a driving force for propelling the vehicle. The motor-generator having a generating function may also be employed as the second motor 5.

A power split mechanism 6 as a transmission mechanism is connected to the engine 3. The power split mechanism 6 includes a power split section 7 that distributes an output torque of the engine 3 to the first motor 4 side and to an output side, and a transmission section 8 that alters a torque split ratio.

For example, a single-pinion planetary gear unit adapted to perform differential action among three rotary elements may be employed as the power split section 7. Specifically, the power split section 7 comprises: a sun gear 9 as a second rotary element; a ring gear 10 as an internal gear arranged concentrically with the sun gear 9; a plurality of pinion gears 11 interposed between the sun gear 9 and the ring gear 10 while meshing with both gears 9 and 10; and a carrier 12 as a first rotary element supporting the pinion gears 11 in a rotatable manner. In the power split section 7, accordingly, the sun gear 9 serves mainly as a reaction element, the ring gear 10 serves mainly as an output element, and the carrier 12 serves mainly as an input element.

An output shaft 13 of the engine 3 is connected to an input shaft 14 of the power split mechanism 6 connected to the carrier 12 so that output power of the engine 3 is applied to the carrier 12. As an option, an additional gear unit may be interposed between the input shaft 14 and the carrier 12, and a damper device and a torque converter may be interposed between the output shaft 13 and the input shaft 14.

The sun gear 9 is connected to the first motor 4. In the example shown in FIG. 1, the power split section 7 and the first motor 4 are arranged concentrically with a rotational center axis of the engine 3, and the first motor 4 is situated on an opposite side of the engine 3 across the power split section 7. The transmission section 8 is interposed coaxially between the power split section 7 and the engine 3.

Specifically, the transmission section 8 is a single-pinion planetary gear unit comprising: a sun gear 15; a ring gear 16 as a third rotary element arranged concentrically with the sun gear 15; a plurality of pinion gears 17 interposed between the sun gear 15 and the ring gear 16 while meshing with both gears 17 and 18; and a carrier 18 supporting the pinion gears 17 in a rotatable manner. Thus, the transmission section 8 is also adapted to perform a differential action among the sun gear 15, the ring gear 16, and the carrier 18. In the transmission section 8, the sun gear 15 is connected to the ring gear 10 of the power split section 7, and the ring gear 16 is connected to an output gear 19 as an output member.

In order to use the power split section 7 and the transmission section 8 as a complex planetary gear unit, a low clutch C_Lo is disposed to selectively connect the carrier 18 of the transmission section 8 to the carrier 12 of the power split section 7. For example, a wet-type multiple plate clutch or a dog clutch may be adopted as the low clutch C_Lo. Thus, in the powertrain 2 shown in FIG. 1, the power split section 7 is connected to the transmission section 8 to serve as a complex planetary gear unit by engaging the low clutch C_Lo. In the complex planetary gear unit, the carrier 12 of the power split section 7 is connected to the carrier 18 of the transmission section 8 to serve as an input element, the sun gear 9 of the power split section 7 serves as a reaction element, and the ring gear 16 of the transmission section 8 serves as an output element.

A high clutch C_Hi is arranged to rotate the rotary elements of the transmission section 8 integrally. For example, a friction clutch and a dog clutch may also be employed as the high clutch C_Hi to selectively connect the carrier 18 to the ring gear 16 or the sun gear 15, or to connect the sun gear 15 to the ring gear 16. In the powertrain 2 shown in FIG. 1, specifically, the high clutch C_Hi is adapted to connect the carrier 18 to the ring gear 16.

The low clutch C_Lo and the high clutch C_Hi are arranged coaxially with the engine 3, the power split section 7, and the transmission section 8 on the opposite side of the power split section 7 across the transmission section 8. The low clutch C_Lo and the high clutch C_Hi may be arranged not only in parallel to each other in a radial direction but also in tandem in an axial direction. In the powertrain 2 shown in FIG. 1, the low clutch C_Lo and the high clutch C_Hi are arranged radially parallel to each other and hence an axial length of the powertrain is shortened. Instead, given that the low clutch C_Lo and the high clutch C_Hi are arranged coaxially with each other, outer diameters of those clutches are not restricted, and the number of friction plates of the frictional clutch may thus be reduced.

A counter shaft 20 extends parallel to the common rotational axis of the engine 3, the power split section 7, and the transmission section 8. A driven gear 21 is fitted onto one end of the counter shaft 20 to be meshed with the output gear 19, and a drive gear 22 is fitted onto the other end of the counter shaft 20 to be meshed with a ring gear 24 of a differential gear unit 23 as a final reduction.

The driven gear 21 is also meshed with a drive gear 26 fitted onto a rotor shaft 25 of the second motor 5 so that power or torque of the second motor 5 is synthesized with power or torque of the output gear 19 at the driven gear 21 to be distributed from the differential gear unit 23 to the front wheels 1R and 1L via each driveshaft 27.

In order to selectively stop a rotation of the output shaft 13 or the input shaft 14 for the purpose of delivering the drive torque generated by the first motor 4 to the front wheels 1R and 1L, a brake B is arranged in the powertrain 2. For example, a friction clutch and a dog clutch may also be employed as the brake B. Specifically, the carrier 12 of the power split section 7 and the carrier 18 of the transmission section 8 are allowed to serve as reaction elements, and the sun gear 9 of the power split section 7 is allowed to serve as an input element by applying the brake B1 to halt the output shaft 13 or the input shaft 14. To this end, the brake B may be adapted to stop the rotation of the output shaft 13 or the input shaft 14 not only completely but also incompletely to apply a reaction torque to those shafts. Instead, a one-way clutch that restricts a reverse rotation of the output shaft 13 or the input shaft 14 with respect to a rotational direction of the engine 3 may also be adopted as the brake B.

A first power control system 28 is connected to the first motor 4, and a second power control system 29 is connected to the second motor 5. Each of the first power control system 28 and the second power control system 29 includes an inverter and a converter. The first power control system 28 and the second power control system 29 are connected to each other, and also connected to an electric storage device 30 including a lithium ion battery, a capacitor, and a solid-state battery. For example, when the first motor 4 is operated as a generator while establishing a reaction torque, an electric power generated by the first motor 4 may be supplied to the second motor 5 without passing through the electric storage device 30.

In order to control the first power control system 28, the second power control system 29, the low clutch C_Lo, the high clutch C_Hi, the brake B and so on, the vehicle is provided with an electronic control unit (to be abbreviated as the “ECU” hereinafter) 31 as a controller. The ECU 31 has a microcomputer as its main constituent that is configured to execute a calculation based on incident data transmitted from sensors as well as maps and formulas installed in advance. Calculation results are transmitted from the ECU 31 in the form of command signal. To this end, for example, the ECU 31 receives data transmitted from: an accelerator sensor that detects a position of an accelerator pedal; a brake sensor that detects a depression of a brake pedal; a vehicle speed sensor that detects a speed of the vehicle; a battery sensor that detects a state of charge (to be abbreviated as “SOC” hereinafter) level of the electric storage device 30; temperature sensors that detect temperatures of the electric storage device 30, the first motor 4, and the second motor 5; motor speed sensors that detect speeds of the first motor 4 and the second motor 5; an external sensor such as a radar that detects an external condition of the vehicle; a navigation system; a GPS, and so on.

In the vehicle shown in FIG. 1, an operating mode may be selected from a hybrid mode (to be abbreviated as the “HV mode” hereinafter) in which the vehicle is propelled by a drive torque generated by the engine 3, and an electric vehicle mode (to be abbreviated as the “EV mode” hereinafter) in which the vehicle is propelled by drive torques generated by the first motor 4 and the second motor 5 without using the engine 3. The HV mode may be selected from a hybrid-low mode (to be abbreviated as the “HV-Low mode” hereinafter) as a “low mode” of the embodiment, a hybrid-high mode (to be abbreviated as the “HV-High mode” hereinafter) as a “high mode” of the embodiment, and a fixed mode. Specifically, in the HV-Low mode, a ratio of the output torque of the engine 3 mechanically delivered to the output gear 19 through the power split mechanism 6 (i.e., a split ratio) is relatively large. By contrast, in the HV-High mode, the ratio of the output torque of the engine 3 mechanically delivered to the output gear 19 through the power split mechanism 6 is relatively small. In the fixed mode, the output torque of the engine 3 is delivered to the output gear 19 without being changed.

For example, in the HV-Low mode, a torque Te generated by the engine 3 is delivered to the output gear 19 at a ratio expressed as “(1/(1-ρ1·ρ2)Te”. Whereas, in the HV-High mode, the torque Te generated by the engine 3 is delivered to the output gear 19 at a ratio expressed as “(1/(1+ρ1))Te”. In the fixed mode, the torque Te generated by the engine 3 is delivered to the output gear 19 without being changed. In the above expressions, “p 1” is a gear ratio between teeth number of the ring gear 10 and teeth number of the sun gear 9, and “ρ2” is a gear ratio between teeth number of the ring gear 16 and teeth number of the sun gear 15. Specifically, “ρ1” and “ρ2” are smaller than “1”. That is, in the HV-Low mode, a ratio of the torque delivered to the output gear 19 is increased in comparison with that in the HV-High mode. Therefore, the HV-Low mode is selected when launching the vehicle in the forward direction. Accordingly, the ratio “(1/(1-ρ1·ρ2)” corresponds to a first predetermined ratio of the exemplary embodiment of the present disclosure, and the ratio “(1/(1+ρ1))” corresponds to a second predetermined ratio of the exemplary embodiment of the present disclosure.

In the HV-Low mode and the HV-High mode as continuously variable modes, a speed of the engine 3 may be changed continuously by controlling a speed of the first motor 4. Whereas, in the fixed mode, the output gear 19 is rotated at a same speed as a speed of the engine 3.

The EV mode may be selected from a dual-motor mode in which both of the first motor 4 and the second motor 5 generate drive torques to propel the vehicle, and a single-motor mode in which only the second motor 5 generates a drive torque to propel the vehicle. Further, the dual-motor mode may be selected from an electric vehicle-low mode (to be abbreviated as the “EV-Low mode” hereinafter) in which a torque of the first motor 4 is multiplied by a relatively larger factor, and an electric vehicle-high mode (to be abbreviated as the “EV-High mode” hereinafter) in which a torque of the first motor 4 is multiplied by a relatively smaller factor. In the single-motor mode, the vehicle Ve is powered only by the second motor 5 while engaging the low clutch C_Lo, while engaging the high clutch C_Hi, or while disengaging both of the low clutch C_Lo and the high clutch C_Hi.

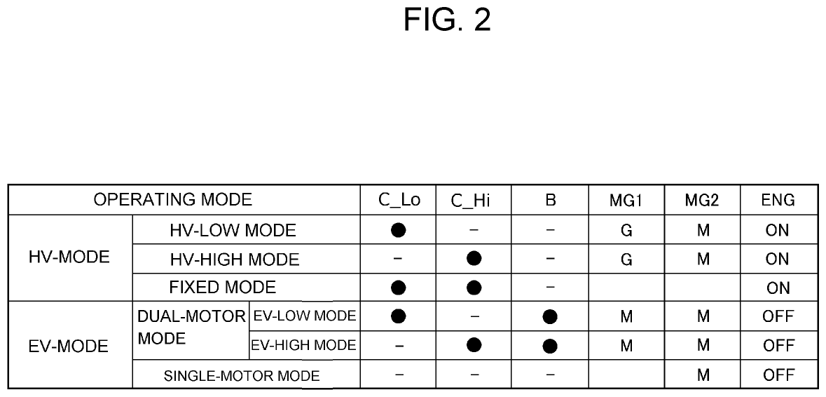

FIG. 2 shows engagement states of the low clutch C_Lo, the high clutch C_Hi, and the brake B1, and operating states of the first motor 4, the second motor 5, and the engine 3 in each operating mode. In FIG. 2, “•” represents that the engagement device is in engagement, “−” represents that the engagement device is in disengagement, “G” represents that the motor serves mainly as a generator, “M” represents that the motor serves mainly as a motor, blank represents that the motor serves as neither a motor nor a generator or that the motor is not involved in propulsion of the vehicle, “ON” represents that the engine 3 generates a drive torque, and “OFF” represents that the engine 3 does not generate a drive torque.

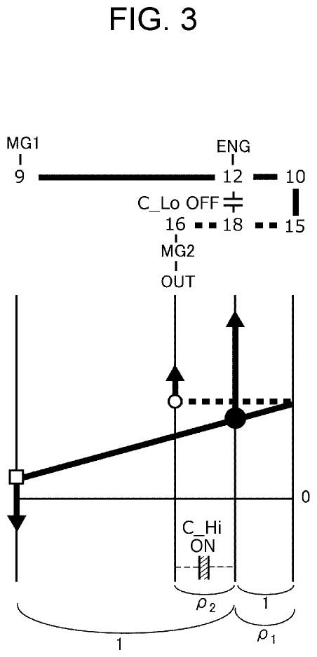

Rotational speeds of the rotary elements of the power split mechanism 6, and directions of torques of the engine 3, the first motor 4, and the second motor 5 in each operating mode are indicated in FIGS. 3 to 8. In the nomographic diagrams shown in FIGS. 3 to 8, distances among the vertical lines represents a gear ratio of the power split mechanism 6, a vertical distance on the vertical line from the horizontal base line represents a rotational speed of the rotary member, an orientation of the arrow represents a direction of the torque, and a length of the arrow represents a magnitude of the torque.

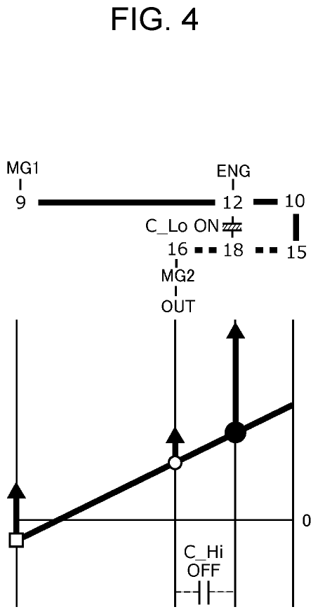

In the HV-High mode, as indicated in FIG. 3, the high clutch C_Hi is engaged, and the engine 3 generates a drive torque while the first motor 4 generates a reaction torque. In the HV-Low mode, as indicated in FIG. 4, the low clutch C_Lo is engaged, and the engine 3 generates a drive torque while the first motor 4 generates a reaction torque. In the HV-High mode and the HV-Low mode, a rotational speed of the first motor 4 is controlled in such a manner as to optimize a total energy efficiency in the powertrain 2 including a fuel efficiency of the engine 3 and a driving efficiency of the first motor 4. Specifically, the total energy efficiency in the powertrain 2 may be calculated by dividing a total energy consumption by a power to rotate the front wheels 1R and 1L. A rotational speed of the first motor 4 may be varied continuously, and the rotational speed of the engine 3 is governed by the rotational speed of the first motor 4 and a vehicle speed. That is, the power split mechanism 6 may serve as a continuously variable transmission.

As a result of establishing a reaction torque by the first motor 4, the first motor 4 serves as a generator. In the above-mentioned situations, therefore, a power of the engine 3 is partially translated into an electric energy, and the remaining power of the engine 3 is delivered to the ring gear 16 of the transmission section 8. As described, the split ratio of the torque distributed from the engine 3 to the first motor 4 side and to the ring gear 16 (or the output gear 19) differs between the HV-Low mode and the HV-High mode. Specifically, in the HV-Low mode, the torque of the engine 3 delivered to the ring gear 16 is greater than that in the HV-High mode. By contrast, in the HV-Low mode, a reaction torque generated by the first motor 4 is less than that in the HV-High mode.

The electric power generated by the first motor 4 is supplied to the second motor 5 and the electric storage device 30. Specifically, when an electric power generated by the first motor 4 is greater than a required electric power to operate the second motor 5, the required electric power is supplied to the second motor 5 and a surplus electric power is accumulated in the electric storage device 30. By contrast, when the electric power generated by the first motor 4 is less than the required electric power to operate the second motor 5, the electric power is supplied to the second motor 5 not only from the first motor 4 but also from the electric storage device.

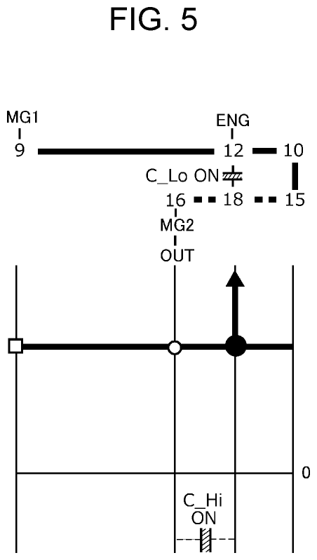

In the fixed mode, as indicated in FIG. 5, both of the low clutch C_Lo and the high clutch C_Hi are engaged so that all of the rotary elements in the power split mechanism 6 are rotated at same speeds. In other words, the output power of the engine 3 will not be translated into an electric energy by the first motor 4 and the second motor 5. For this reason, a power loss associated with such energy conversion will not be caused in the fixed mode and hence power transmission efficiency can be improved. It is to be noted that the electric storage device may also be charged by operating the first motor 4 and the second motor 5 as generators even in the fixed mode.

During propulsion in the HV mode, the engine 3 generates a total power of a required power to propel the vehicle and a required power to charge the electric storage device 30 irrespective of a running direction. In this situation, a speed of the engine 3 is adjusted in an optimally fuel efficient manner by controlling a speed of the first motor 4.

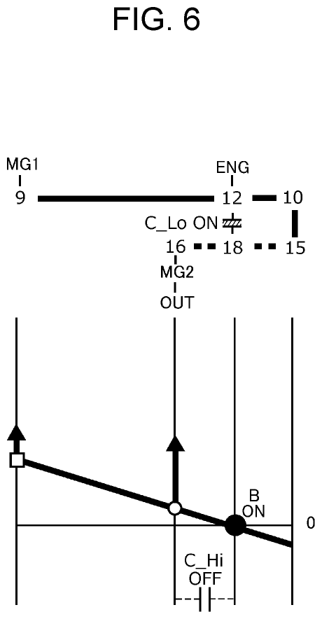

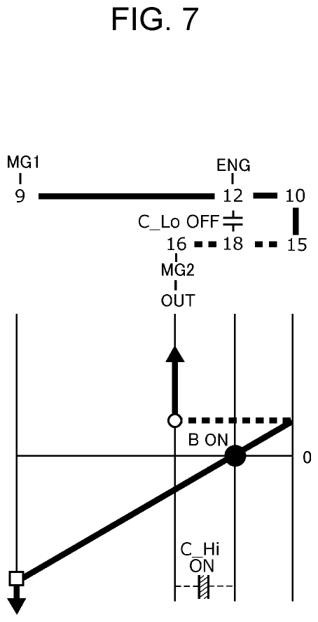

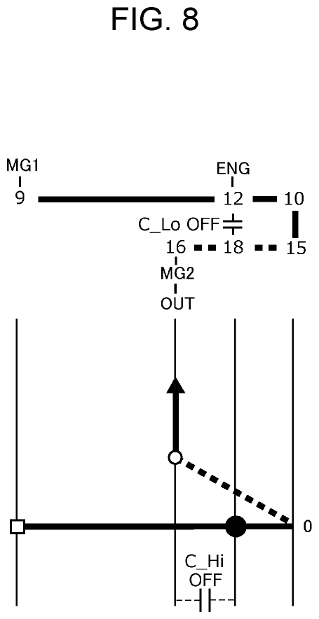

As indicated in FIGS. 6 and 7, in the EV-Low mode and the EV-High mode, the brake B1 is engaged, and the first motor 4 and the second motor 5 generates the drive torques to propel the vehicle Ve. In the EV-Low mode, a ratio of a rotational speed of the ring gear 16 in the transmission section 8 to a rotational speed of the first motor 4 is greater than that in the EV-High mode. That is, a speed reducing ratio in the EV-Low mode is greater than that in the EV-High mode. In the EV-Low mode, therefore, a larger driving force may be generated. As indicated in FIG. 8, in the single-motor mode, only the second motor 5 generates a drive torque, and both of the low clutch C_Lo and the high clutch C_Hi are disengaged. In the single-motor mode, therefore, all of the rotary elements of the power split mechanism 6 are halted. For this reason, the engine 3 and the first motor 4 will not be rotated passively, and hence a power loss can be reduced.

Thus, in the case of generating the torque by the engine 3 as indicated in FIGS. 3 and 4, the first motor 4 generates the reaction torque to prevent an excessive rise in the speed of the engine 3. Consequently, the torque generated by the engine 3 is partially delivered to the front wheels 1R and 1L through the power split mechanism 6 in the direction to propel the vehicle in the forward direction. Therefore, when propelling the vehicle in reverse, it is preferable to operate the vehicle in the single-motor mode.

In a case that a required power to propel the vehicle in reverse is relatively large and may not be achieved only by supplying the electric power to the second motor 5 from the electric storage device 30, the electric power is also supplied to the second motor 5 from the first motor 4. In this case, specifically, the low clutch C_Lo or the high clutch C_Hi is engaged and the engine 3 is activated so that an output power of the engine 3 is partially translated into an electric power by the first motor 4 to be supplied to the second motor 5. To this end, the output power of the engine 3 is set such that the first motor 4 is allowed to compensate for the shortfall of the electric power. In this situation, the torque of the engine 3 being transmitted through the power split mechanism 6 counteracts the reverse torque generated by the second motor 5. Therefore, if a relatively large driving force is required to propel the vehicle in reverse, it is preferable to select the HV-High mode in which the torque transmitted through the power split mechanism 6 is relatively small.

As described, the HV-Low mode is selected when launching the vehicle in the forward direction. That is, when the vehicle is stopped, the HV-Low mode is selected in principle. Therefore, in a case of stopping the vehicle propelling in the forward direction and thereafter launching the vehicle in reverse e.g., on an upward slope where a relatively large driving force is required to launch the vehicle, it is preferable to shift the operating mode from the HV-Low mode to the HV-High mode thereby reducing the torque counteracting the reverse torque generated by the second motor 5. In this case, the driver switches an operating range from a drive range to a reverse drive range by manipulating a range selector lever, and thereafter the operating mode will be shifted from the HV-Low mode to the HV-High mode. However, since the operating mode is shifted during the period from a point at which the range selector lever is operated to a point at which the vehicle starts moving in reverse, it will take some time to launch the vehicle in reverse. In addition, given that the dog clutches are employed as the low clutch C_Lo and the high clutch C_Hi, an engagement noise would be generated when stopping the vehicle as a result of engaging the high clutch C_Hi to shift the operating mode to the HV-High mode.

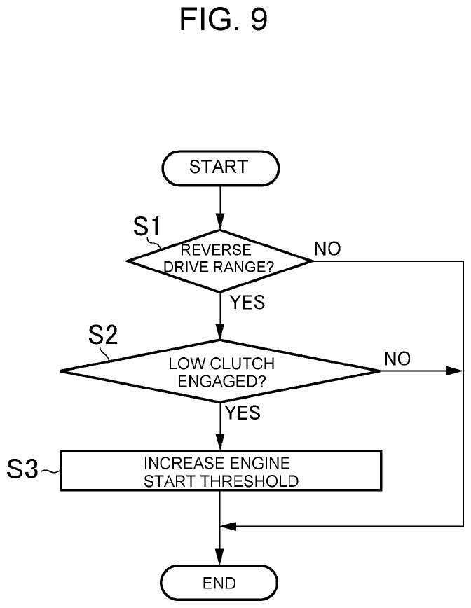

In order to avoid the above-mentioned disadvantages, the control system according to the exemplary embodiment of the present disclosure is configured to allow the vehicle to propel in reverse while stopping the engine 3. To this end, the control system changes an engine start threshold to restrict a startup of the engine 3 from a predetermined normal value that is a threshold of the case in which a restricting condition to restrict the start-up of the engine 3 is not satisfied. In other words, the control system changes the engine start threshold to widen an operating region of the vehicle in which the vehicle is powered only by the second motor 5. According to the exemplary embodiment of the present disclosure, since the vehicle is propelled in reverse without starting the engine 3 and without manipulating the clutches, the vehicle can be launched promptly in reverse when the operating range is switched to the reverse drive range. For this purpose, the control system according to the exemplary embodiment of the present disclosure executes the routines shown in the accompanying drawings. Turning to FIG. 9, there is shown a first example of the routine executed by the ECU 31 of the control system according to the exemplary embodiment of the present disclosure. At step S1, it is determined whether the reverse drive range is selected based e.g., on an operation to move the range selector lever to a reverse drive position.

If the reverse drive range is not selected so that the answer of step S1 is NO, the routine returns. By contrast, if the reverse drive range is selected so that the answer of step S1 is YES, the routine progresses to step S2 to determine whether only the low clutch C_Lo is in engagement. In other words, at step S2, it is determined whether the operating mode of the vehicle is expected to be the HV-Low mode when starting the engine 3. For example, such determination at step S2 may be made based on a fact that a command signal to engage the low clutch C_Lo is transmitted to an actuator of the low clutch C_Lo and that a command signal to disengage the high clutch C_Hi is transmitted to an actuator of the high clutch C_Hi. Instead, such determination at step S2 may also be made based on a fact that only the actuator of the low clutch C_Lo is in an engagement position. According to the exemplary embodiment of the present disclosure, the restricting condition to restrict the startup of the engine 3 is satisfied if the reverse drive range is selected and the HV-Low mode is established by the power split mechanism 6 as a transmission mechanism.

If the low clutch C_Lo is disengaged, or if both of the low clutch C_Lo and the high clutch C_Hi are engaged so that the answer of step S2 is NO, the routine returns. By contrast, if only the low clutch C_Lo is engaged so that the answer of step S2 is YES, the routine progresses to step S3 to increase the engine start threshold from the normal value by a predetermined additional value, and thereafter returns. The engine start threshold is a threshold to determine that the operating mode of the vehicle is required to be shifted from the EV mode to the HV mode. According to the first example shown in FIG. 9, a required driving force or a required power governed by a position of the accelerator pedal and a speed of the vehicle may be employed as a parameter of the engine start threshold. That is, the engine is started when the required driving force or the required power is increased to or greater than the engine start threshold.

In the vehicle shown in FIG. 1, the operating region in which the EV mode is selected is set such that the EV mode is selected when a power smaller than a maximum output power of the second motor 5 is required to propel the vehicle. That is, an upper limit value of the required power in the operating region in which the EV mode is selected is set by subtracting a predetermined margin value from the maximum output power of the second motor 5. Here, it is to be noted that the maximum power of the second motor 5 varies depending on a temperature of the second motor 5 itself, a temperature of the electric storage device 30, an SOC level of the electric storage device 30 and so on. Therefore, the engine start threshold may be a variable to be adjusted depending on the above-mentioned parameters.

The above-mentioned additional value to be added to the engine start threshold is set within the above-mentioned margin value of the output power of the second motor 5, and the additional value may also be a variable to be adjusted depending on the required power to propel the vehicle.

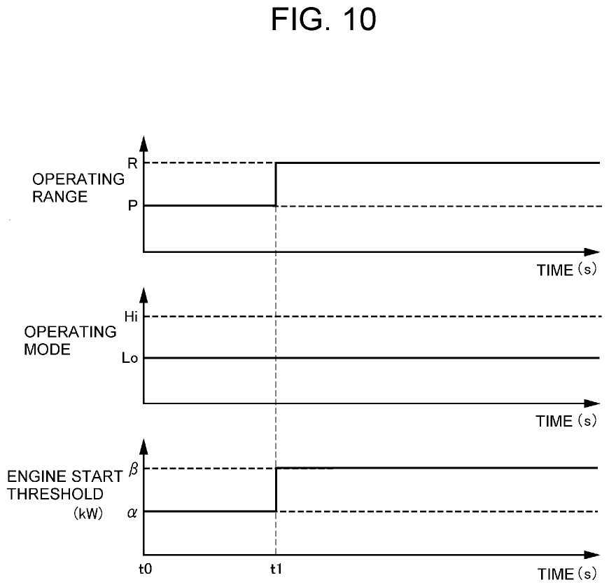

Turning to FIG. 10, there is shown a temporal change in the engine start threshold during execution of the routine shown in FIG. 9. At point t0, the vehicle is stopped and a parking range (indicated by P in FIG. 10) is selected. In this situation, therefore, the answer of step S1 is NO, and the engine start threshold is still maintained to a predetermined initial value αs the normal value. When the vehicle is stopped, the operating range is expected to be shifted to the drive range in most cases and hence the low clutch C_Lo is engaged in this situation.

At point t1, the range selector lever is operated to shift the operating range from the parking range to the reverse drive range (indicated by R in FIG. 10), and consequently the routine progresses from step S1 to step S2. In this situation, since the low clutch C_Lo is engaged, the routine further progresses from step S2 to step S3. Consequently, the engine start threshold is increased at point t1 by the predetermined additional value.

As a result, the operating region in which the EV mode is selected is expanded so that the second motor 5 is allowed to generate a greater driving force without starting the engine 3. In this situation, therefore, the vehicle may be launched in reverse only by the driving force generated by the second motor 5 while engaging the low clutch C_Lo. For this reason, a required time to launch the vehicle in reverse after selecting the reverse drive range may be reduced. In addition, even if the dog clutches are employed as the low clutch C_Lo and the high clutch C_Hi, it is not necessary to engage the high clutch C_Hi. For this reason, an engagement noise will not be generated by the high clutch C_Hi.

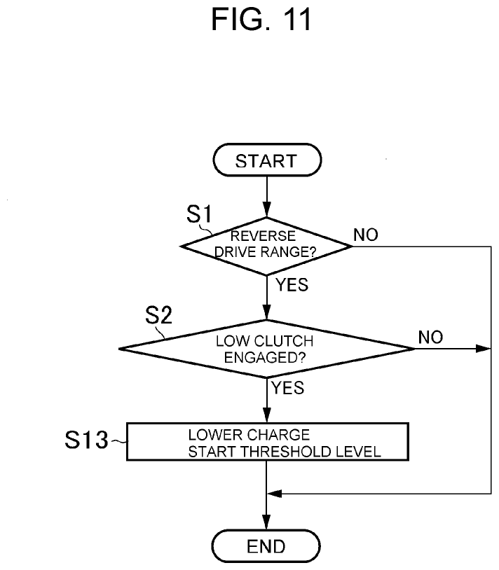

Turning to FIG. 11, there is shown a second example of the routine executed by the ECU 31. In the routine shown in FIG. 11, contents of steps S1 and S2 are identical to those of the routine shown in FIG. 9. According to the second example, if only the low clutch C_Lo is engaged so that the answer of step S2 is YES, the routine progresses to step S13 to lower a charge start threshold level of the electric storage device 30 by a predetermined reduction percentage from an initial level α to a predetermined level ß, and thereafter returns. The initial level α is a predetermined normal level that is the charge start threshold level of the case in which the restricting condition is not satisfied. The charge start threshold level is set such that the engine 3 is started to charge the electric storage device 30 before the electric storage device 30 runs out of charge. That is, the engine 3 is started to charge the electric storage device 30 when an SOC level of the electric storage device 30 falls to the charge start threshold level or lower. To this end, the charge start threshold level is set predetermined level higher than a lower limit charge level of the electric storage device 30 so that a predetermined margin is maintained between the charge start threshold level and the lower limit charge level. According to the example shown in FIG. 11, the above-mentioned reduction percentage to lower the charge start threshold level is set within the above-mentioned predetermined margin of the SOC level, and the charge start threshold level may be varied to be adjusted depending e.g., on a discharge power corresponding to the required power to propel the vehicle.

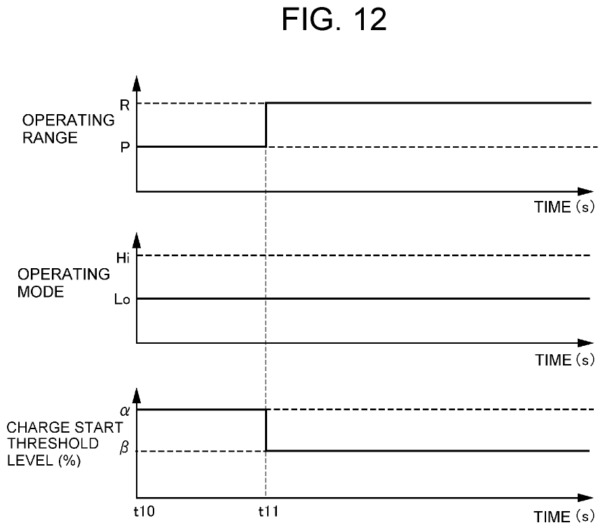

Turning to FIG. 12, there is shown a temporal change in the charge start threshold level during execution of the routine shown in FIG. 11. At point t10, the vehicle is stopped and a parking range (indicated by P in FIG. 12) is selected. In this situation, therefore, the answer of step S1 is NO, and the charge start threshold level is still maintained to the initial level a. When the vehicle is stopped, the operating range is expected to be shifted to the drive range in most cases and hence the low clutch C_Lo is engaged in this situation.

At point t11, the range selector lever is operated to shift the operating range from the parking range to the reverse drive range (indicated by R in FIG. 12), and consequently the routine progresses from step S1 to step S2. In this situation, since the low clutch C_Lo is engaged, the routine further progresses from step S2 to step S13. Consequently, the charge start threshold level is lowered at point t11 to the predetermined level ß.

As a result, the engine 3 is prevented from being started to charge the electric storage device 30 before the operating range is shifted from the parking range to the reverse drive range. In this situation, therefore, a torque of the engine 3 will not be applied to the front wheels 1R and 1L when the operating range is shifted from the parking range to the reverse drive range, and the vehicle may be launched in reverse without manipulating the clutches. For this reason, a required time to launch the vehicle in reverse after selecting the reverse drive range may be reduced. In addition, since the engine 3 is not started, the driving force to propel the vehicle in reverse will not be reduced by the torque of the engine 3.

According to the exemplary embodiment of the present disclosure, parameter other than the required power to propel the vehicle and the SOC level may also be employed to set a threshold to restrict a startup of the engine 3. Here, when propelling the vehicle in reverse, the routines shown in FIGS. 9 and 11 may be executed simultaneously.

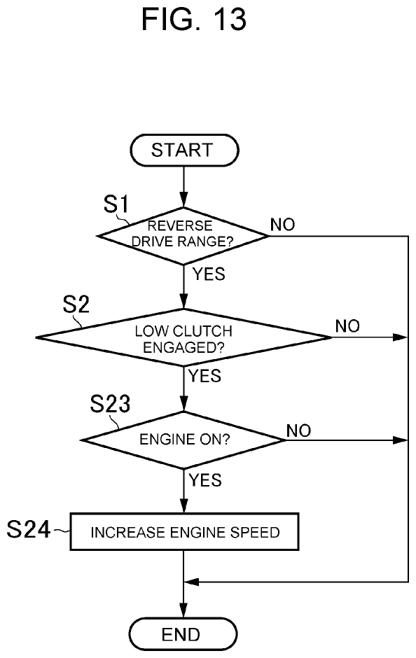

Turning to FIG. 13, there is shown a third example of the routine executed by the ECU 31. According to the third example, a reduction in the driving force to launch the vehicle in reverse can be prevented without manipulating the clutches. In the routine shown in FIG. 13, contents of steps S1 and S2 are identical to those of the foregoing examples. According to the third example, if only the low clutch C_Lo is engaged so that the answer of step S2 is YES, the routine progresses to step S23 to determine whether the engine 3 is in operation. For example, such determination at step S23 may be made based on a transmission of a command signal to a fuel injector.

If the engine 3 is not activated so that the answer of step S23 is NO, the routine returns. By contrast, if the engine 3 is activated so that the answer of step S23 is YES, the routine progresses to step S24 to increase a speed of the engine 3 from a normal value that is an engine speed of the case in which the restricting condition is not satisfied, while maintaining an output power of the engine 3, and thereafter returns. In other words, at step S24, an output torque of the engine 3 is reduced from a normal value that is an engine torque of the case in which the restricting condition is not satisfied, while maintaining an output power of the engine 3. At step S24, specifically, the speed of the engine 3 is increased such that the output torque of the engine 3 is adjusted to a substantially same magnitude as an output torque of the engine 3 given that the engine 3 is operated in an optimally fuel efficient manner in the HV-High mode.

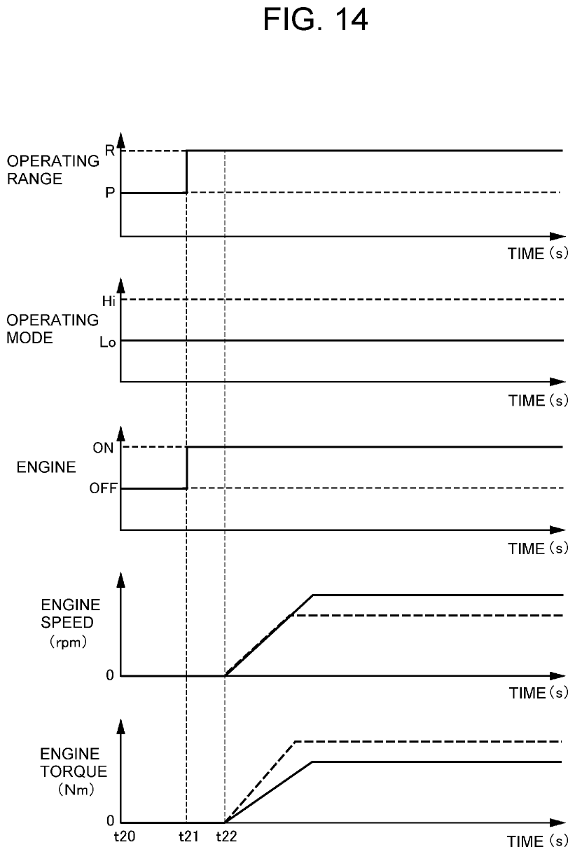

Turning to FIG. 14, there is shown a temporal change in conditions of the engine 3 during execution of the routine shown in FIG. 13. At point t20, the vehicle is stopped and the parking range (indicated by P in FIG. 14) is selected. In this situation, therefore, the answer of step S1 is NO, and the engine 3 has not yet been started.

At point t21, the range selector lever is operated to shift the operating range from the parking range to the reverse drive range (indicated by R in FIG. 14), and consequently the routine progresses from step S1 to step S2. In this situation, an engine starting flag is turned on at a same timing as the operating range is shifted to the reverse drive range so that a speed and a torque of the engine 3 are increased from point t22.

As a result of thus starting the engine 3, the routine progresses from step S23 to step S24. Consequently, as indicated by the solid line in FIG. 14, the speed of the engine 3 is increased higher than a speed of the engine 3 as the normal value indicated by the dashed line which is increased by starting the engine 3 without executing the routine shown in FIG. 13. Whereas, in order to maintain the output power of the engine 3, the torque of the engine 3 indicated by the solid line in FIG. 14 is maintained less than the torque of the engine 3 as the normal value indicated by the dashed line which is increased by starting the engine 3 without executing the routine shown in FIG. 13.

By thus increasing the speed of the engine 3, the speed of the first motor 4 is also increased. Likewise, by thus reducing the torque of the engine 3, the reaction torque of the first motor 4 is also reduced. In this case, therefore, a generation amount of the first motor 4 will not be changed significantly irrespective of whether the speed of the engine 3 is increased.

Thus, according to the third example shown in FIG. 13, the speed of the engine 3 is increased higher than the speed at which the fuel efficiency is optimized in the case that the operating range is shifted to the reverse drive range and that the low clutch C_Lo is in engagement. As a result, the torque of the engine 3 may be reduced while maintaining the output power of the engine 3. That is, the torque of the engine 3 counteracting the torque to propel the vehicle in reverse may be reduced. In this situation, therefore, the vehicle is allowed to be propelled in reverse while maintaining the low clutch C_Lo to be engaged so that a required time to launch the vehicle in reverse after selecting the reverse drive range is reduced. In addition, since the output torque of the engine 3 is reduced, the driving force to propel the vehicle in reverse will not be reduced by the torque of the engine 3.

As described, in the HV mode, the engine 3 generates a total power of a required power to propel the vehicle and a required power to charge the electric storage device 30. Therefore, the required output power to be generated by the engine 3 may be reduced by temporarily reducing the required power to charge the electric storage device 30. Consequently, an output torque of the engine 3 may be reduced even if the engine 3 is operated at a speed possible to optimize the fuel efficiency, compared to a normal value of the case in which the required power to charge the electric storage device 30 is not reduced.

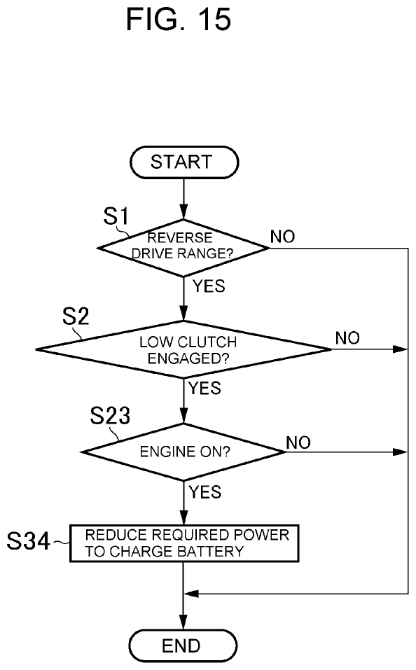

That is, in the case of launching the vehicle in reverse while maintaining the low clutch C_Lo to be engaged, a reduction in the driving force to propel the vehicle may also be prevented by reducing the required power to charge the electric storage device 30. Turning to FIG. 15, there is shown a fourth example of the routine executed by the ECU 31 to prevent a reduction in the driving force to launch the vehicle in reverse. In the routine shown in FIG. 15, contents of steps S1 and S2 are identical to those of the foregoing examples. According to the fourth example, if only the low clutch C_Lo is engaged so that the answer of step S2 is YES, the routine also progresses to step S23 to determine whether the engine 3 is in operation.

If the engine 3 is not activated so that the answer of step S23 is NO, the routine returns. By contrast, if the engine 3 is activated so that the answer of step S23 is YES, the routine progresses to step S34 to reduce the required power to be generated by the engine 3 to charge the electric storage device 30 from the normal value that is the required power of the case in which the restricting condition is not satisfied, and thereafter returns. That is, at step S34, an output power of the engine 3 is temporarily reduced. To this end, specifically, a speed of the engine 3 is adjusted to a speed at which the fuel efficiency of the engine 3 is optimized while generating a total power of a required power to propel the vehicle and the required power to charge the electric storage device 30 reduced at step S34.

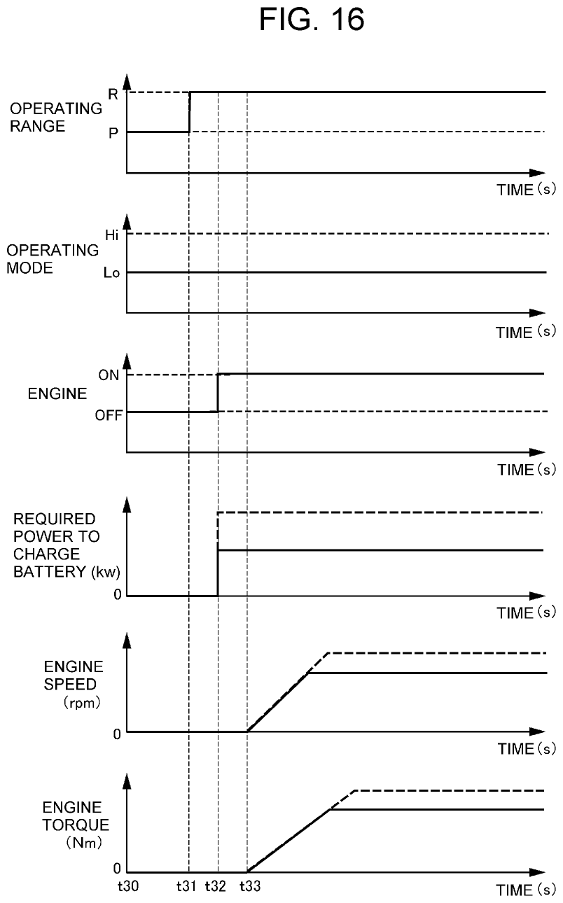

Turning to FIG. 16, there is shown a temporal change in conditions of the engine 3 and the required power to charge the electric storage device 30 during execution of the routine shown in FIG. 15. At point t30, the vehicle is stopped and the parking range (indicated by P in FIG. 16) is selected. In this situation, therefore, the answer of step S1 is NO, and the engine 3 has not yet been started.

At point t31, the range selector lever is operated to shift the operating range from the parking range to the reverse drive range (indicated by R in FIG. 16), and consequently the routine progresses from step S1 to step S2. According to the example shown in FIG. 16, the engine starting flag is still off when the operating range is shifted to the reverse drive range, that is, the engine 3 has not yet been started at point t31.

At point t32, the engine starting flag is turned on, and the routine progresses from step S23 to step S34. Consequently, as indicated by the solid line in FIG. 16, the required power to charge the electric storage device 30 is increased from zero to a level lower than the required power to charge the electric storage device 30 indicated by the dashed line which is increased without executing the routine shown in FIG. 15. As a result, a speed and a torque of the engine 3 are increased from point t33 but individually maintained to lower levels compared to those of the case in which the routine shown in FIG. 15 is not executed.

Thus, according to the fourth example shown in FIG. 15, the required power to charge the electric storage device 30 is reduced in the case that the operating range is shifted to the reverse drive range and that the low clutch C_Lo is in engagement. According to the fourth example shown in FIG. 15, therefore, the torque of the engine 3 may be reduced even if the speed of the engine 3 is adjusted to optimize the fuel efficiency. That is, the torque of the engine 3 counteracting the torque to propel the vehicle in reverse may be reduced. In this situation, therefore, the vehicle is allowed to be propelled in reverse while maintaining the low clutch C_Lo to be engaged so that a required time to launch the vehicle in reverse after selecting the reverse drive range is reduced. In addition, since the output torque of the engine 3 is reduced, the driving force to propel the vehicle in reverse will not be reduced by the torque of the engine 3.

Thus, according to the routines shown in FIGS. 9 and 11, the thresholds are adjusted to restrict a startup of the engine 3. Whereas, according to the routines shown in FIGS. 13 and 15, the output torque of the engine 3 is reduced after starting the engine 3 compared to the case of propelling the vehicle in the forward direction or the case of launching the vehicle while engaging the high clutch C_Hi. Therefore, the routine shown in FIG. 9 or 11 may be executed to adjust the threshold to start the engine 3 when launching the vehicle in reverse, and the routine shown in FIG. 13 or 15 may be executed thereafter if the required driving force or the SOC level of the electric storage device 30 changes further than the adjusted threshold. Otherwise, the routines shown in FIGS. 9 and 11 may also be executed in combination with the routines shown in FIGS. 13 and 15.

In the case of executing the routine shown in FIG. 9, 11, or 15, an output power of the electric storage device 30 is increased and the SOC level of the electric storage device 30 is lowered. In those cases, therefore, the electric storage device 30 would be damaged if the low clutch C_Lo is engaged for a long time. Whereas, in the case of executing the routine shown in FIG. 13, an operating point of the engine 3 governed by a speed and a torque thereof is deviated from an optimally fuel efficient point. In this case, therefore, the fuel efficiency of the engine 3 would be reduced. In order to avoid such disadvantages, according to the exemplary embodiment of the present disclosure, the high clutch C_Hi may be engaged instead of the low clutch C_Lo after moving the vehicle in reverse for a predetermined period of time.

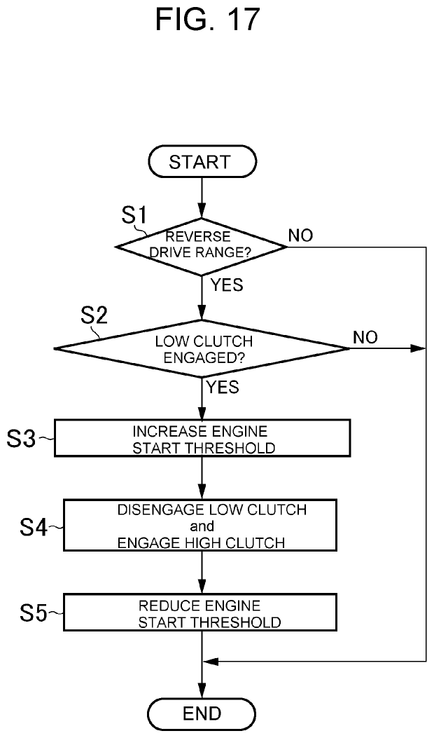

For this purpose, the control system according to the exemplary embodiment of the present disclosure is further configured to execute routines shown in FIGS. 17, 19, 21, and 23. Turning to FIG. 17, there is shown a fifth example of the routine executed by the ECU 31. In the routine shown in FIG. 17, contents of steps S1 and S2 are identical to those of the foregoing examples. According to the fifth example, if only the low clutch C_Lo is engaged so that the answer of step S2 is YES, the routine progresses to step S3 to increase the engine start threshold by the predetermined additional value αs the first example shown in FIG. 9. Then, at step S4, the low clutch C_Lo is disengaged and the high clutch C_Hi is engaged after a lapse of a predetermined period of time. At step S4, specifically, the low clutch C_Lo is disengaged first of all. Then, a speed difference between the carrier 18 and the ring gear 16 is reduced by controlling a speed of the first motor 4. In the case that the vehicle is propelled in reverse while engaging the low clutch C_Lo, the first motor 4 is rotated in the opposite direction to the rotational direction of the engine 3, and hence the carrier 18 is rotated in the opposite direction to the rotational direction of the ring gear 16. That is, the speed difference between the carrier 18 and the ring gear 16 may be reduced by rotating the first motor 4 in the same direction as the rotational direction of the engine 3, and the high clutch C_Hi is engaged when the speed difference between the carrier 18 and the ring gear 16 is reduced to a predetermined value. As described, the high clutch C_Hi is engaged instead of the low clutch C_Lo for the purpose of limiting the damage of the electric storage device 30. For this purpose, the above-mentioned period of time is counted only during the movement of the vehicle in reverse, and a period of time in which the vehicle is stopped is exempted from the above-mentioned period of time.

By thus engaging the high clutch C_Hi instead of the low clutch C_Lo, the torque of the engine 3 delivered to the front wheels 1R and 1L through the power split mechanism 6 may be reduced compared to the case of maintaining the engagement of the low clutch C_Lo. Therefore, at step S5, the engine start threshold is reduced to an initial value α as the normal value before increased at step S3, and thereafter the routine returns. In this situation, if the operating range is shifted to the drive range, the engine start threshold is also reduced to the initial value α.

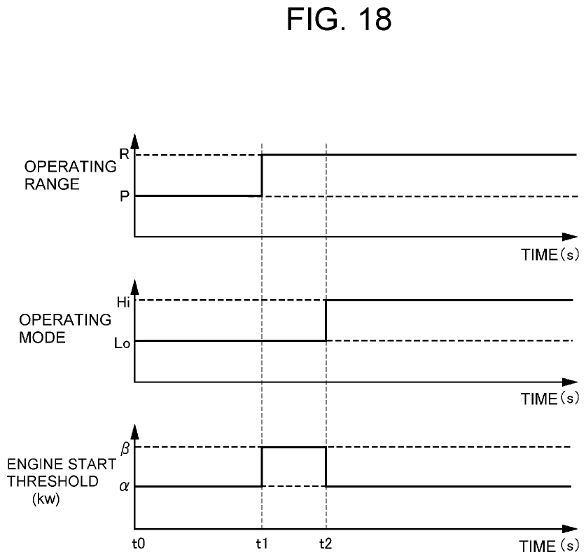

Turning to FIG. 18, there is shown a temporal change in the engine start threshold during execution of the routine shown in FIG. 17. In the example shown in FIG. 18, as the example shown in FIG. 10, the engine start threshold is increased at point t1 by the predetermined additional value. After the lapse of the predetermined period of time from point t1, the low clutch C_Lo is disengaged and the high clutch C_Hi is engaged at point t2 (i.e., at step S4) so that the operating mode is shifted from the HV-Low mode to the HV-High mode. In this situation, the engine start threshold is reduced to the initial value α.

By thus reducing the engine start threshold to the initial value α after moving the vehicle in reverse for the predetermined period of time, a load on the electric storage device 30 may be lightened to limit damage of the electric storage device 30. In addition, the torque of the engine 3 delivered to the front wheels 1R and 1L through the power split mechanism 6 may be reduced to prevent a reduction in the driving force to propel the vehicle. Further, since the HV-High mode is expected to be selected when launching the vehicle in reverse, the driver may not be concerned about an engagement noise of the high clutch C_Hi.

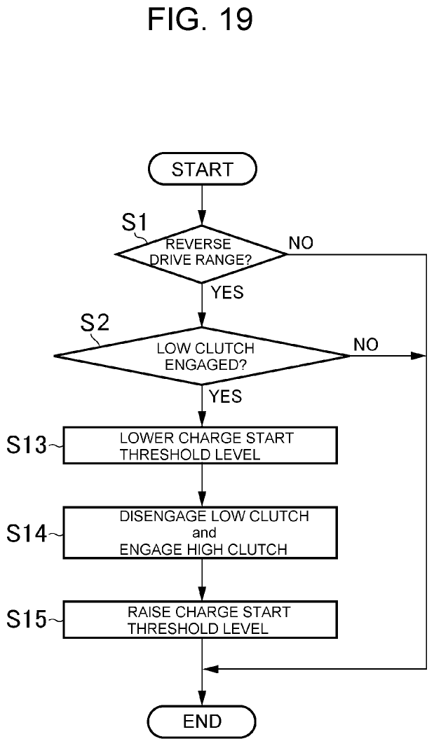

Turning to FIG. 19, there is shown a sixth example of the routine executed by the ECU 31. In the routine shown in FIG. 19, contents of steps S1 and S2 are identical to those of the foregoing examples. According to the sixth example, if only the low clutch C_Lo is engaged so that the answer of step S2 is YES, the routine progresses to step S13 to lower the charge start threshold level of the electric storage device 30 from an initial level α as the normal level to the predetermined level ß as the second example shown in FIG. 11. Then, at step S14, the low clutch C_Lo is disengaged and the high clutch C_Hi is engaged by the procedures of step S4 of the second example, after a lapse of a predetermined period of time.

By thus engaging the high clutch C_Hi instead of the low clutch C_Lo, the torque of the engine 3 delivered to the front wheels 1R and 1L through the power split mechanism 6 may be reduced compared to the case of maintaining the engagement of the low clutch C_Lo. Therefore, at step S15, the charge start threshold level of the electric storage device 30 is raised to the initial level α, and thereafter the routine returns. In this situation, if the operating range is shifted to the drive range, the charge start threshold level of the electric storage device 30 is also raised to the initial level α.

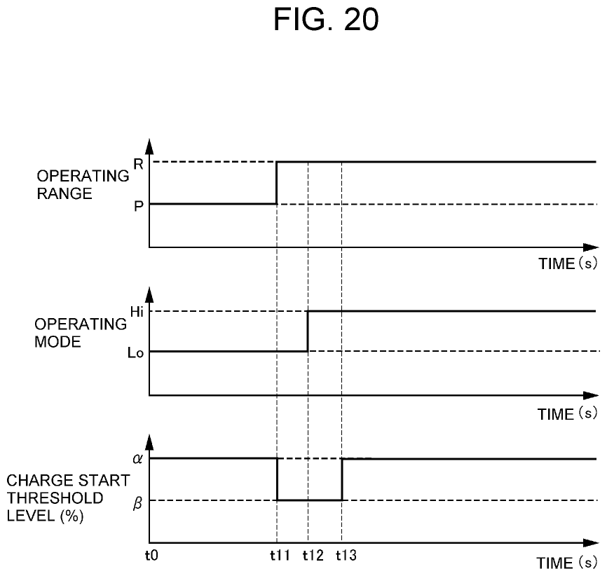

Turning to FIG. 20, there is shown a temporal change in the charge start threshold level of the electric storage device 30 during execution of the routine shown in FIG. 19. In the example shown in FIG. 20, as the example shown in FIG. 12, the charge start threshold level of the electric storage device 30 is lowered to the predetermined level ß at point t11. After the lapse of the predetermined period of time from point t11, the low clutch C_Lo is disengaged and the high clutch C_Hi is engaged at point t12 (i.e., at step S14) so that the operating mode is shifted from the HV-Low mode to the HV-High mode. Then, at point t13, the charge start threshold level of the electric storage device 30 is raised to the initial level α again.

By thus raising the charge start threshold level to the initial level α after propelling the vehicle in reverse for the predetermined period of time, a load on the electric storage device 30 may be lightened to limit damage of the electric storage device 30. In addition, the torque of the engine 3 delivered to the front wheels 1R and 1L through the power split mechanism 6 may be reduced to prevent a reduction in the driving force to propel the vehicle. Further, since the HV-High mode is expected to be selected when launching the vehicle in reverse, the driver may not be concerned about an engagement noise of the high clutch C_Hi.

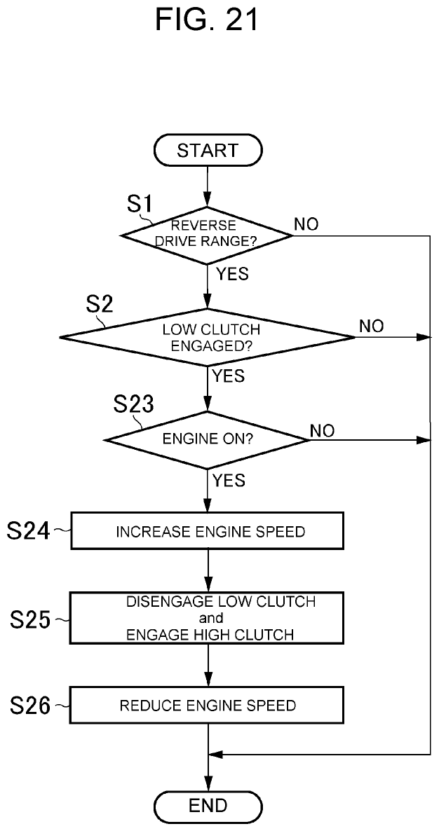

Turning to FIG. 21, there is shown a seventh example of the routine executed by the ECU 31. In the routine shown in FIG. 21, contents of steps S1 and S2 are identical to those of the foregoing examples. According to the seventh example, if only the low clutch C_Lo is engaged so that the answer of step S2 is YES, the routine progresses to step S23 to determine whether the engine 3 is in operation. If the engine 3 is activated so that the answer of step S23 is YES, the routine progresses to step S24 to increase a speed of the engine 3 from the normal value αs the example shown in FIG. 13. Then, at step S25, the low clutch C_Lo is disengaged and the high clutch C_Hi is engaged by the procedures of e.g., step S4 of the second example, after a lapse of a predetermined period of time.

By thus engaging the high clutch C_Hi instead of the low clutch C_Lo, the torque of the engine 3 delivered to the front wheels 1R and 1L through the power split mechanism 6 may be reduced compared to the case of maintaining the engagement of the low clutch C_Lo. Therefore, at step S26, the speed of engine 3 is reduced to the normal value αt which the fuel efficiency of the engine 3 is optimized, and thereafter the routine returns. In this situation, if the operating range is shifted to the drive range, the speed of engine 3 is reduced to the normal value.

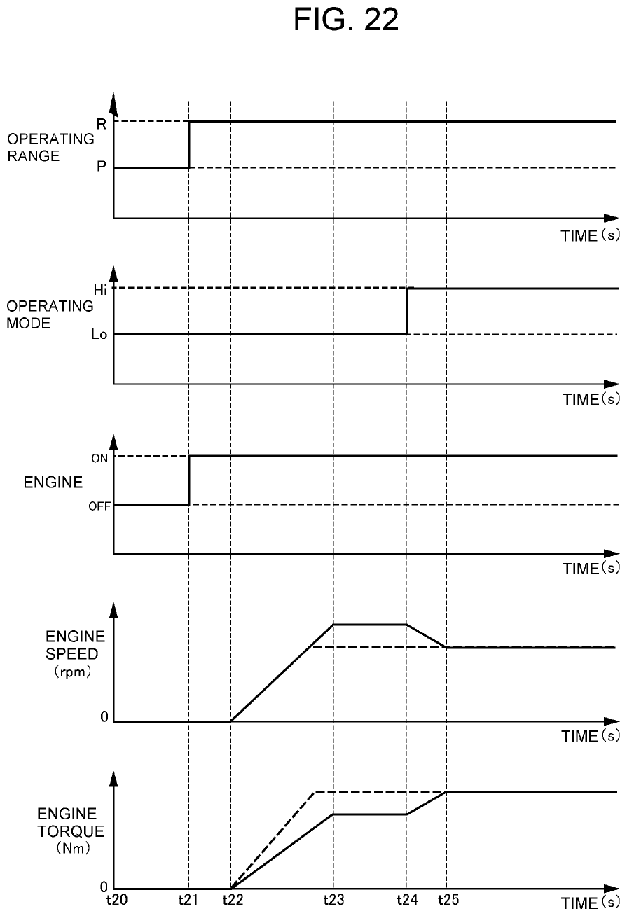

Turning to FIG. 22, there is shown a temporal change in the conditions of the engine 3 during execution of the routine shown in FIG. 21. In the example shown in FIG. 22, as the example shown in FIG. 14, the speed of the engine 3 is increased from point t22, and as indicated by the solid line, the speed of the engine 3 reaches a target value αt point t23 which is higher than the normal value indicated by the dashed line. After the lapse of the predetermined period of time from point t23, the low clutch C_Lo is disengaged and the high clutch C_Hi is engaged at point t24 (i.e., at step S25) so that the operating mode is shifted from the HV-Low mode to the HV-High mode. Then, at point t25, the speed of the engine 3 is reduced to the normal value. In this situation, the torque of the engine 3 is increased to the normal value with the reduction in the speed of the engine 3 so as to maintain the output power of the engine 3.

By thus reducing the speed of the engine 3 after propelling the vehicle in reverse for the predetermined period of time, the fuel efficiency of the engine 3 may be improved. In addition, although the torque of the engine 3 is increased with the reduction in the speed of the engine 3, the torque of the engine 3 delivered to the front wheels 1R and 1L through the power split mechanism 6 may be reduced. Therefore, a reduction in the driving force to propel the vehicle may be prevented. Further, since the HV-High mode is expected to be selected when launching the vehicle in reverse, the driver may not be concerned about an engagement noise of the high clutch C_Hi.

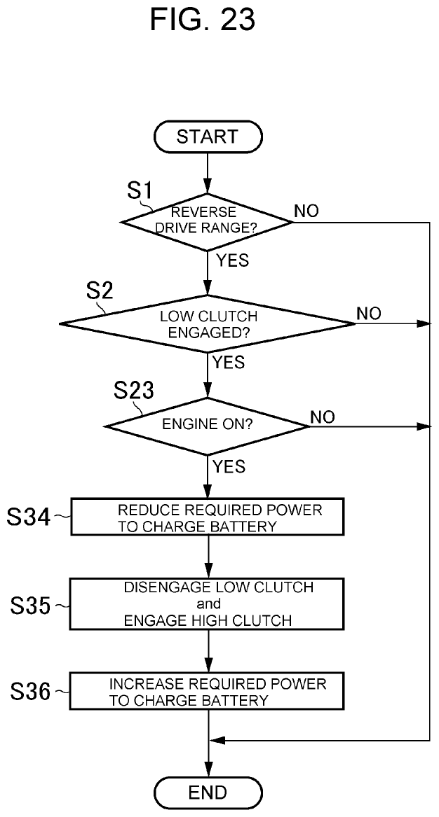

Turning to FIG. 23, there is shown an eighth example of the routine executed by the ECU 31. In the routine shown in FIG. 23, contents of steps S1 and S2 are identical to those of the foregoing examples. According to the eighth example, if only the low clutch C_Lo is engaged so that the answer of step S2 is YES, the routine progresses to step S23 to determine whether the engine 3 is in operation. If the engine 3 is activated so that the answer of step S23 is YES, the routine progresses to step S34 to reduce the required power to be generated by the engine 3 to charge the electric storage device 30 from the normal value by the procedure explained in the fourth example. Then, at step S35, the low clutch C_Lo is disengaged and the high clutch C_Hi is engaged by the procedures of e.g., step S4 of the second example, after a lapse of a predetermined period of time.

By thus engaging the high clutch C_Hi instead of the low clutch C_Lo, the torque of the engine 3 delivered to the front wheels 1R and 1L through the power split mechanism 6 may be reduced compared to the case of maintaining the engagement of the low clutch C_Lo. Therefore, at step S36, the required power to be generated by the engine 3 to charge the electric storage device 30 is increased to the normal value before reduced at step S34, and thereafter the routine returns. In this situation, if the operating range is shifted to the drive range, the required power to be generated by the engine 3 to charge the electric storage device 30 is also increased.

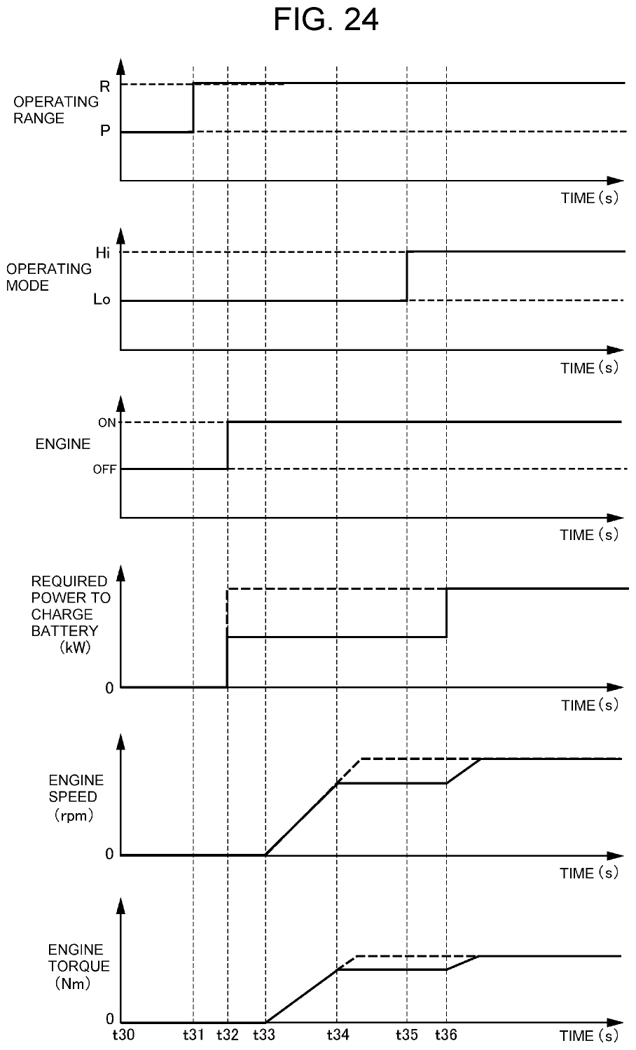

Turning to FIG. 24, there is shown a temporal change in the conditions of the engine 3 and the required power to be generated by the engine 3 to charge the electric storage device 30 during execution of the routine shown in FIG. 23. In the example shown in FIG. 24, as the example shown in FIG. 16, the speed of the engine 3 is increased from point t33, and as indicated by the solid line, the speed of the engine 3 reaches a target value αt point t34 which is lower than the normal value indicated by the dashed line. After the lapse of the predetermined period of time from point t34, the low clutch C_Lo is disengaged and the high clutch C_Hi is engaged at point t35 (i.e., at step S35) so that the operating mode is shifted from the HV-Low mode to the HV-High mode. Then, at point t36, the required power to be generated by the engine 3 to charge the electric storage device 30 is increased to the normal value, and the speed of the engine 3 starts increasing. In this situation, the torque of the engine 3 is increased with the increase in the output power of the engine 3 so as to operate the engine 3 at an optimally fuel efficient point.

By thus increasing the required power to be generated by the engine 3 to charge the electric storage device 30 to the normal value after propelling the vehicle in reverse for the predetermined period of time, an SOC level of the electric storage device 30 will not fall excessively. In addition, although the torque of the engine 3 is increased with the increase in the required power to be generated by the engine 3 to charge the electric storage device 30, the torque of the engine 3 delivered to the front wheels 1R and 1L through the power split mechanism 6 may be reduced. Therefore, a reduction in the driving force to propel the vehicle may be prevented. Further, since the HV-High mode is expected to be selected when launching the vehicle in reverse, the driver may not be concerned about an engagement noise of the high clutch C_Hi.

Thus, the foregoing routines are executed to prevent a reduction in the driving force to propel the vehicle in reverse. As described, when propelling the vehicle in reverse, the output torque of the engine 3 delivered to the front wheels 1R and 1L through the power split mechanism 6 counteracts the output torque of the second motor 5 to propel the vehicle in reverse thereby reducing the driving force. As also described, the engine 3 is started if an SOC level of the electric storage device 30 is low, or if an available electric power of the electric storage device 30 is low. That is, the foregoing routines may be executed only when a large driving force is required to launch the vehicle in reverse.

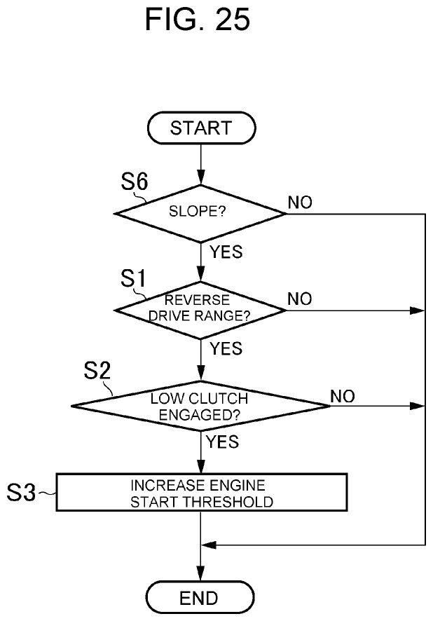

For this purpose, for example, the first example shown in FIG. 9 may be modified as a ninth example shown in FIG. 25. According to the ninth example, first of all, it is determined at step S6 whether the vehicle is currently located on an upward slope. That is, at step S6, it is determined whether a large driving force is required to launch the vehicle in reverse. In other words, it is determined whether the vehicle is oriented in a direction to climb the upslope backwardly. For example, such determination at step S6 may be made based on data collected by the sensors and the radar. Instead, such determination at step S6 may also be made based on an IP address or positional information collected by the GPS. Further, at step S6, it is also possible to determine whether an upward slope or a step exists within a predetermined distance from the vehicle travelling in reverse.

If the vehicle is not located on an upward slope so that the answer of step S6 is NO, the routine returns. By contrast, if the vehicle is located on an upward slope so that the answer of step S6 is YES, the routine progresses to step S1 to execute the routine shown in FIG. 9.

By thus increasing the engine start threshold, lowering the charge start threshold level, or increasing the speed of the engine 3 only when a large driving force is required to propel the vehicle in the reverse direction, the damage of the electric storage device 30 may be limited and the fuel efficiency of the vehicle may be improved.

If the SOC level of the electric storage device 30 is sufficiently high when launching the vehicle in reverse, an available electric power or energy of the electric storage device 30 to be supplied to the second motor 5 may be increased. Consequently, a greater driving force to propel the vehicle in reverse may be established, and a distance to propel the vehicle in reverse may be increased. For these purposes, the control system according to the exemplary embodiment of the present disclosure is further configured to raise the SOC level of the electric storage device 30 when the vehicle is expected to climb an upward slope in reverse.

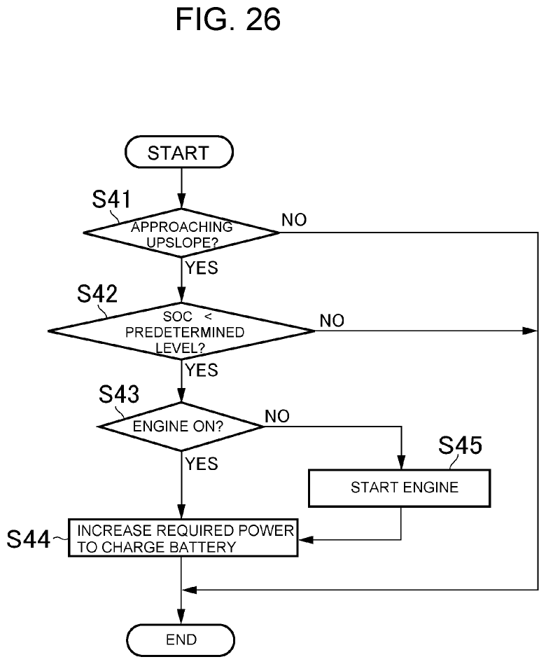

Specifically, the control system according to the exemplary embodiment of the present disclosure is further configured to execute a tenth example of the routine shown in FIG. 26. According to the tenth example, first of all, it is determined at step S41 whether the vehicle is expected to climb an upward slope in reverse. In other words, at step S41, it is determined whether the vehicle travelling in reverse is approaching an upward slope. For example, such determination at step S41 may be made based on an IP address or positional information collected by the GPS. Instead, such determination at step S41 may also be made based on a travel history stored in the ECU 31. Here, it is to be noted that the routine according to the tenth example may be executed irrespective of whether the vehicle travels in the forward direction or the reverse direction.

If the vehicle is not approaching an upward slope so that the answer of step S41 is NO, the routine returns. By contrast, if the vehicle is approaching an upward slope so that the answer of step S41 is YES, the routine progresses to step S42 to determine whether a current SOC level of the electric storage device 30 is lower than a predetermined level. Specifically, the predetermined level employed at step S42 is set to a level higher than the charge start threshold level employed at step S13 of the routine shown in FIG. 11, at which the vehicle can be powered to climb an upward slope in reverse only by the second motor 5 until the vehicle is parked. For example, such determination at step S42 may be made based on a detection signal of the battery sensor or an output voltage of the electric storage device 30.

If the current SOC level of the electric storage device 30 is higher than the predetermined level so that the answer of step S42 is NO, the electric storage device 30 is charged sufficiently to propel the vehicle in reverse only by the second motor 5. In this case, therefore, the routine returns. By contrast, if the current SOC level of the electric storage device 30 is lower than the predetermined level so that the answer of step S42 is YES, the routine progresses to step S44 to determine whether the engine 3 is in operation. For example, such determination at step S43 may also be made based on a transmission of the command signal to the fuel injector.

If the engine 3 is activated so that the answer of step S43 is YES, the routine progresses to step S44 to increase a required power to be generated by the engine 3 to charge the electric storage device 30 by a predetermined amount, and thereafter returns. At step S44, specifically, the electric storage device 30 is charged rapidly by increasing an output power of the engine 3 to increase a generation amount of the first motor 4. That is, an electric power to be charged into the electric storage device 30 is increased to increase the SOC level of the electric storage device 30. To this end, for example, the predetermined amount may be set to a value corresponding to a difference between the current SOC level and the aforementioned predetermined level. Instead, the predetermined amount may also be a variable which varies according to e.g., a distance to an upward slope.

By contrast, if the engine 3 is not activated so that the answer of step S43 is NO, the routine progresses to step S45 to start the engine 3, and further progresses to step S44. Thereafter, the routine returns.

The engine 3 may be stopped after raising the SOC level of the electric storage device 30 to a desired level.

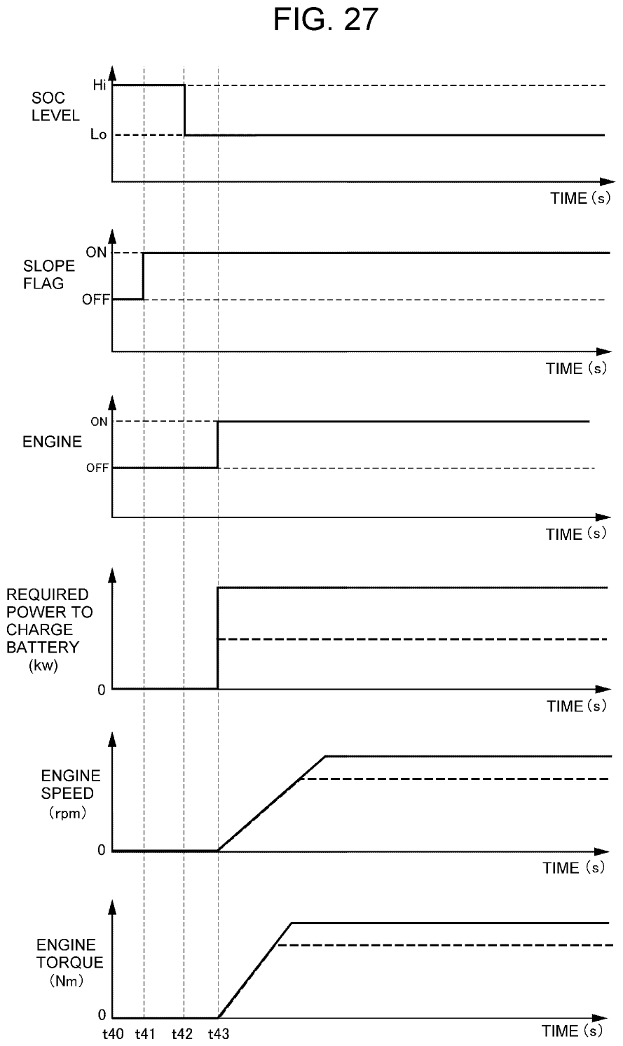

Turning to FIG. 27, there is shown a temporal change in the required power to be generated by the engine 3 to charge the electric storage device 30 during execution of the routine shown in FIG. 26. Specifically, FIG. 27 shows an example in which the engine 3 being stopped is started at step S45 to charge the electric storage device 30.

At point t40, the engine 3 is stopped and hence a speed and a torque of the engine 3 are zero, respectively. In this situation, the vehicle has not yet approached an upward slope so that a flag representing an existence of a slope is off, and an SOC level of the electric storage device 30 is higher than the predetermined level.

At point t41, the vehicle approaches the upward slope, and the flag representing an existence of a slope is turned on. In this situation, the SOC level of the electric storage device 30 is still higher than the predetermined level, and hence the engine 3 has not yet been started.

At point t42, the SOC level of the electric storage device 30 falls below the predetermined level, and the engine 3 has not yet been started. In this situation, therefore, the routine progresses from step S43 to S45, and the engine 3 is started at point t43. Consequently, the speed and the torque of the engine 3 are increased from point t43, and the required power to be generated by the engine 3 to charge the electric storage device 30 is increased at point t43 (i.e., at step S44).

As a result, as indicated by the solid lines, the speed and the torque of the engine 3 are increased higher than the speed and the torque indicated by the dashed lines that are increased without executing the routine shown in FIG. 26, so as to avoid a reduction in fuel efficiency due to increase of the output power of the engine 3.

By thus increasing the required power to be generated by the engine 3 to charge the electric storage device 30 when the vehicle approaches an upward slope, the SOC level of the electric storage device 30 may be maintained to a higher level when climbing the slope in reverse. Therefore, an available electric power or energy of the electric storage device 30 to be supplied to the second motor 5 may be increased to propel the vehicle on the upward slope in reverse only by the second motor 5. That is, a greater driving force to propel the vehicle in reverse may be established, and a distance to propel the vehicle in reverse may be increased. For this reason, the vehicle is allowed to climb the slope while stopping the engine 3. In other words, the vehicle is allowed to climb the slope without manipulating the clutches. For this reason, a required time to launch the vehicle in reverse after selecting the reverse drive range may be reduced.

If the engine 3 is started after launching the vehicle in reverse on the upward slope while increasing the required power to be generated by the engine 3, any of the foregoing routines may be executed.

Although the above exemplary embodiments of the present disclosure have been described, it will be understood by those skilled in the art that the present disclosure should not be limited to the described exemplary embodiments, and various changes and modifications can be made within the scope of the present disclosure. For example, the control system according to the exemplary embodiment of the present disclosure may be applied to any kinds of hybrid vehicles in which a torque split ratio to the first motor and the drive wheels may be changed, and a torque is delivered to the drive wheels through the power split mechanism in a direction to reduce a driving force to propel the vehicle in reverse. Specifically, the control system according to the exemplary embodiment of the present disclosure may be applied to a hybrid vehicle comprising: an engine; a motor; a pair of drive wheels; a first differential mechanism that performs a differential action among (i) a first rotary element connected to any one of the engine, the motor, and the drive wheels, (ii) a second rotary element connected to another one of the engine, the motor, and the drive wheels, and (iii) a third rotary element; a second differential mechanism that performs a differential action among (i) a fourth rotary element connected to still another one of the engine, the motor, and the drive wheels, (ii) a fifth rotary element connected to the third rotary element, and (iii) a sixth rotary element; a first engagement device that selectively connects any one of a first pair of the rotary elements including the first rotary element or the second rotary element and the sixth rotary element, and a second pair of the rotary elements including any two of the fourth to sixth rotary elements; and a second engagement device that selectively connects the other one of the first pair and the second pair of the rotary elements. In the hybrid vehicle of this kind, a low mode in which a torque delivered from the engine to the drive wheels is established by engaging the first engagement device, and a high mode in which a torque delivered from the engine to the drive wheels is smaller than that in the low mode is established by engaging the second engagement device.

What is claimed is:

1. A driving force control system for a hybrid vehicle comprising:
an engine;
a first rotary machine; and
a transmission mechanism comprising a first rotary element, a second rotary element, and a third rotary element connected to one another while being allowed to rotate in a differential manner,
wherein the first rotary element is connected to the engine, the second rotary element is connected to the first rotary machine, and the third rotary element is connected to an output member,
an output torque of the engine is delivered to the output member by generating a reaction torque by the first rotary machine,
the transmission mechanism is configured to establish
a low mode in which the output torque of the engine is delivered to the output member at a first predetermined ratio, and
a high mode in which the output torque of the engine is delivered to the output member at a second predetermined ratio that is smaller than the first predetermined ratio,
the hybrid vehicle further comprising:
a second rotary machine that is connected to the output member in a torque transmittable manner; and
an electric storage device that is electrically connected to the first rotary machine and the second rotary machine,
wherein the hybrid vehicle is propelled in reverse by generating a reverse torque by the second rotary machine,
the output torque of the engine delivered to the output member through the transmission mechanism counteracts the reverse torque,
the driving force control system comprising:
a controller that controls the engine, the first rotary machine, and the second rotary machine, and
the controller is configured to change an engine start threshold to restrict a startup of the engine upon satisfaction of a restricting condition, in which the low mode is established by the transmission mechanism, and a reverse drive range is selected.

2. The driving force control system for the hybrid vehicle as claimed in claim 1,
wherein a required driving force or a required power to propel the hybrid vehicle is employed as a parameter of the engine start threshold, and
the controller is further configured to:
start the engine when the required driving force or the required power is increased to or greater than the engine start threshold; and
increase the engine start threshold upon satisfaction of the restricting condition.

3. The driving force control system for the hybrid vehicle as claimed in claim 1,
wherein the first rotary machine translates a power generated by the engine into an electric power to be supplied to the electric storage device,
the engine start threshold includes a charge start threshold level of a state of charge level of the electric storage device,
the controller is further configured to:
start the engine when the state of charge level of the electric storage device falls to the charge start threshold level or lower; and
lower the charge start threshold level upon satisfaction of the restricting condition.

4. The driving force control system for the hybrid vehicle as claimed in claim 1, wherein the controller is further configured to:
set an output power of the engine to a total power of a required power to propel the hybrid vehicle and a required power to charge the electric storage device when operating the engine; and
reduce the output torque of the engine upon satisfaction of the restricting condition.

5. The driving force control system for the hybrid vehicle as claimed in claim 4, wherein the controller is further configured to reduce the output torque of the engine by increasing a speed of the engine while maintaining the output power of the engine upon satisfaction of the restricting condition.

6. The driving force control system for the hybrid vehicle as claimed in claim 4, wherein the controller is further configured to reduce the output torque of the engine by reducing the required power to charge the electric storage device by the engine upon satisfaction of the restricting condition.

7. The driving force control system for the hybrid vehicle as claimed in claim 1, wherein the controller is further configured to control the transmission mechanism to shift from the low mode to the high mode, and to return the engine start threshold which has been changed to an initial value, after a lapse of a predetermined period of time from a point at which the hybrid vehicle has started to propel in reverse.

8. The driving force control system for the hybrid vehicle as claimed in claim 4, wherein the controller is further configured to control the transmission mechanism to shift from the low mode to the high mode, and to increase the output torque of the engine which has been reduced to a normal value, after a lapse of a predetermined period of time from a point at which the hybrid vehicle has started to propel in reverse.

9. The driving force control system for the hybrid vehicle as claimed in claim 1, wherein the controller is further configured to:
determine whether the hybrid vehicle is expected to travel in reverse on a road where a driving force greater than a predetermined value is required; and
change the engine start threshold if the hybrid vehicle is expected to travel in reverse on the road where the driving force greater than the predetermined value is required.

10. The driving force control system for the hybrid vehicle as claimed in claim 4, wherein the controller is further configured to:
determine whether the hybrid vehicle is expected to travel in reverse on a road where a driving force greater than a predetermined value is required; and
reduce the output torque of the engine if the hybrid vehicle is expected to travel in reverse on the road where the driving force greater than the predetermined value is required.

11. The driving force control system for the hybrid vehicle as claimed in claim 1, wherein the controller is further configured to:
determine whether the hybrid vehicle travelling in reverse approaches a road where a driving force greater than a predetermined value is required; and
increase an electric power to be charged into the electric storage device if the hybrid vehicle travelling in reverse approaches the road where the driving force greater than the predetermined value is required.

12. The driving force control system for the hybrid vehicle as claimed in claim 11, wherein the controller is further configured to start the engine to increase the electric power to be charged into the electric storage device if the engine was stopped when the hybrid vehicle approached the road where the driving force greater than the predetermined value is required.

13. A driving force control system for a hybrid vehicle comprising:
an engine;
a first rotary machine; and
a transmission mechanism comprising a first rotary element, a second rotary element, and a third rotary element connected to one another while being allowed to rotate in a differential manner,
wherein the first rotary element is connected to the engine, the second rotary element is connected to the first rotary machine, and the third rotary element is connected to an output member,
an output torque of the engine is delivered to the output member by generating a reaction torque by the first rotary machine,
the transmission mechanism is configured to establish
a low mode in which the output torque of the engine is delivered to the output member at a first predetermined ratio, and
a high mode in which the output torque of the engine is delivered to the output member at a second predetermined ratio that is smaller than the first predetermined ratio,
the hybrid vehicle further comprising:
a second rotary machine that is connected to the output member in a torque transmittable manner; and
an electric storage device that is electrically connected to the first rotary machine and the second rotary machine,
wherein the hybrid vehicle is propelled in reverse by generating a reverse torque by the second rotary machine,
the output torque of the engine delivered to the output member through the transmission mechanism counteracts the reverse torque,
the driving force control system comprising:
a controller that controls the engine, the first rotary machine, and the second rotary machine, and
the controller is configured to:
set an output power of the engine to a total power of a required power to propel the hybrid vehicle and a required power to charge the electric storage device when operating the engine; and
reduce the output torque of the engine upon satisfaction of a restricting condition, in which the low mode is established by the transmission mechanism, and a reverse drive range is selected.

14. The driving force control system for the hybrid vehicle as claimed in claim 13, wherein the controller is further configured to reduce the output torque of the engine by increasing a speed of the engine while maintaining the output power of the engine upon satisfaction of the restricting condition.

15. The driving force control system for the hybrid vehicle as claimed in claim 13, wherein the controller is further configured to reduce the output torque of the engine by reducing the required power to charge the electric storage device by the engine upon satisfaction of the restricting condition.

16. The driving force control system for the hybrid vehicle as claimed in claim 13, wherein the controller is further configured to control the transmission mechanism to shift from the low mode to the high mode, and to increase the output torque of the engine which has been reduced to a normal value, after a lapse of a predetermined period of time from a point at which the hybrid vehicle has started to propel in reverse.

17. The driving force control system for the hybrid vehicle as claimed in claim 13, wherein the controller is further configured to:
determine whether the hybrid vehicle is expected to travel in reverse on a road where a driving force greater than a predetermined value is required; and
reduce the output torque of the engine if the hybrid vehicle is expected to travel in reverse on the road where the driving force greater than the predetermined value is required.

18. The driving force control system for the hybrid vehicle as claimed in claim 13, wherein the controller is further configured to:
determine whether the hybrid vehicle travelling in reverse approaches a road where a driving force greater than a predetermined value is required; and
increase an electric power to be charged into the electric storage device if the hybrid vehicle travelling in reverse approaches the road where the driving force greater than the predetermined value is required.

19. The driving force control system for the hybrid vehicle as claimed in claim 18, wherein the controller is further configured to start the engine to increase the electric power to be charged into the electric storage device if the engine was stopped when the hybrid vehicle approached the road where the driving force greater than the predetermined value is required.

20. A driving force control system for a hybrid vehicle comprising:
an engine;
a first rotary machine; and
a transmission mechanism comprising a first rotary element, a second rotary element, and a third rotary element connected to one another while being allowed to rotate in a differential manner,
wherein the first rotary element is connected to the engine, the second rotary element is connected to the first rotary machine, and the third rotary element is connected to an output member,
an output torque of the engine is delivered to the output member by generating a reaction torque by the first rotary machine,
the transmission mechanism is configured to establish
a low mode in which the output torque of the engine is delivered to the output member at a first predetermined ratio, and
a high mode in which the output torque of the engine is delivered to the output member at a second predetermined ratio that is smaller than the first predetermined ratio,
the hybrid vehicle further comprising:
a second rotary machine that is connected to the output member in a torque transmittable manner; and
an electric storage device that is electrically connected to the first rotary machine and the second rotary machine,
wherein the hybrid vehicle is propelled in reverse by generating a reverse torque by the second rotary machine,
the output torque of the engine delivered to the output member through the transmission mechanism counteracts the reverse torque,
the driving force control system comprising:
a controller that controls the engine, the first rotary machine, and the second rotary machine, and
the controller is configured to:
determine whether the hybrid vehicle travelling in reverse approaches a road where a driving force greater than a predetermined value is required; and
increase an electric power to be charged into the electric storage device if the hybrid vehicle travelling in reverse approaches the road where the driving force greater than the predetermined value is required.

21. The driving force control system for the hybrid vehicle as claimed in claim 20, wherein the controller is further configured to start the engine to increase the electric power to be charged into the electric storage device if the engine was stopped when the hybrid vehicle approached the road where the driving force greater than the predetermined value is required.
